(19) United States
(12) Patent Application Publication
(10) Pub. No.: US 2024/0406711 A1
(43) Pub. Date: Dec. 5, 2024

(54) ELECTRONIC DEVICE SUPPORTING PROFILE TRANSFER BETWEEN ELECTRONIC DEVICES AND OPERATING METHOD THEREOF

(71) Applicant: Samsung Electronics Co., Ltd., Suwon-si (KR)

(72) Inventors: Jieun JUNG, Suwon-si (KR); Hyongjin BAN, Suwon-si (KR)

(21) Appl. No.: 18/670,141

(22) Filed: May 21, 2024

Related U.S. Application Data
(63) Continuation of application No. PCT/KR2024/006656, filed on May 16, 2024.

(30) Foreign Application Priority Data
May 30, 2023 (KR) 10-2023-0069324
Aug. 29, 2023 (KR) 10-2023-0113390

(51) Int. Cl. H04W 8/20; H04W 8/26

(52) U.S. Cl. CPC H04W 8/205; H04W 8/26

(57) ABSTRACT

An electronic device is provided. The electronic device includes at least one communication circuit, at least one processor, and memory storing instructions. The instructions, when executed by the at least one processor, cause the electronic device to identify a user input which triggers a profile transfer from an external electronic device to the electronic device, provide information related to the profile transfer based on the user input, and obtain, from the external electronic device, information for downloading a profile, and the information related to the profile transfer includes information indicating that the information related to the profile transfer is provided by the electronic device to download the profile.

### CROSS-REFERENCE TO RELATED APPLICATION(S)

This application is a continuation application, claiming priority under § 365(c), of an International application No. PCT/KR2024/006656, filed on May 16, 2024, which is based on and claims the benefit of a Korean patent application number 10-2023-0069324, filed on May 30, 2023, in the Korean Intellectual Property Office, and of a Korean patent application number 10-2023-0113390, filed on Aug. 29, 2023, in the Korean Intellectual Property Office, the disclosure of each of which is incorporated by reference herein in its entirety.

### TECHNICAL FIELD

The disclosure relates to an electronic device supporting profile transfer between electronic devices and an operating method thereof.

### BACKGROUND ART

In a wireless communication system, an electronic device (e.g., a user equipment (UE)) may access a wireless communication network and use a communication service such as a voice communication service or a data communication service at a fixed location or while moving.

To provide the electronic device with the communication service, a suitable authenticating process is required. Generally, a universal integrated circuit card (UICC) is inserted into the electronic device, and the authenticating process may be performed between the electronic device and a server of a mobile network operator (MNO) which is a communication provider via a universal subscriber identity module (USIM) installed in the UICC. The UICC may be called a subscriber identity module (SIM) card in a global system for mobile communications (GSM) scheme and may be called a universal subscriber identity module (USIM) card in a wideband code division multiple access (WCDMA), long term evolution (LTE), and/or new radio (NR) schemes.

If a user of the electronic device subscribes to a communication service provided by the communication provider, the communication provider may provide the user with a UICC (e.g., a SIM card or a USIM card), and the user may insert the UICC provided from the communication provider into the electronic device. If the UICC is inserted into the electronic device, a USIM application installed in the UICC may be executed, and the suitable authenticating process may be performed, based on an encryption key value for authentication and an international mobile subscriber identity (IMSI) value stored in the UICC, with the server of the communication provider at which the same IMSI value and encryption key value are stored. If authentication for the electronic device via the authenticating process is successful, the electronic device may use the communication service.

When being manufactured, the UICC is manufactured as a dedicated card for a specific communication provider according to a request of the corresponding communication provider, and authentication information (e.g., a USIM application and a subscriber ID (e.g., an IMSI) for network access of the corresponding communication provider, and an encryption key value (e.g., a known K value or Ki value) may be loaded in advance. The UICC may be provided to a subscriber of a communication service through the corresponding communication provider, and the communication provider may perform various management operations such as installation, modification, and deletion of an application within the UICC using various technologies such as over the air (OTA) if necessary.

A user may insert the UICC into the electronic device to use a network and an application service of the corresponding communication provider, and may use various information as it is in a new electronic device such as authentication-related information, a phone number, and a personal phone book, which have been stored at the corresponding UICC, by inserting, into the new electronic device, the removable UICC inserted into the existing electronic device when replacing the electronic device.

Unlike the UICC which is manufactured and distributed exclusively for the communication provider, a scheme has been proposed in which a user may purchase a UICC or subscribe (or purchase) to a communication service at a time point after obtaining the UICC, and as the user performs subscription and termination, and opening to the communication provider, and/or subscription transfer (e.g., profile transfer or line transfer (number transfer)) to another communication provider, a USIM application, a subscriber ID, and an encryption key value of the communication provider may be remotely installed in the UICC, and authentication information of various communication providers may be safely and flexibly installed and managed.

For example, a so-called embedded UICC (eUICC) capable of remotely installing a profile for providing a communication service via a network without replacing the UICC even if the user changes the communication provider has been proposed. For example, the eUICC may be fixed in a form of a chip within the electronic device during a manufacturing process of the electronic device and manufactured as a preloaded UICC. So, the eUICC may be used in various electronic devices which may have a structure in which it is not easy to attach and detach the UICC physically, such as a machine to machine (M2M) device or a device to device (D2D) device as well as a general electronic device such as a smartphone. An eUICC may also be referred to as an embedded SIM (eSIM).

For a case based on a physical SIM card, a user may detach the physical SIM from an electronic device (e.g., an existing electronic device) and then insert the physical SIM into an external electronic device (e.g., a new electronic device). Accordingly, a subscription (or a line) of the corresponding SIM may be transferred from the electronic device to the external electronic device.

However, for a case based on an eSIM or a soft SIM rather than the physical SIM card, transferring the subscription (or line, or profile) from the electronic device to another electronic device may have limitations in various aspects such as security, authentication, and/or user convenience.

The above information is presented as background information only to assist with an understanding of the disclosure. No determination has been made, and no assertion is made, as to whether any of the above might be applicable as prior art with regard to the disclosure.

### DETAILED DESCRIPTION OF THE INVENTION

### Technical Solution

Aspects of the disclosure are to address at least the above-mentioned problems and/or disadvantages and to provide at least the advantages described below. Accordingly, an aspect of the disclosure is to provide an electronic device supporting profile transfer between electronic devices and an operating method thereof.

Additional aspects will be set forth in part in the description which follows and, in part, will be apparent from the description, or may be learned by practice of the presented embodiments.

In accordance with an aspect of the disclosure, an electronic device (101) is provided. The electronic device includes at least one communication circuit (190), at least one processor (120), and memory (130) storing instructions.

According to an embodiment of the disclosure, the instructions, when executed by the at least one processor, cause the electronic device to identify a user input which triggers a profile transfer from an external electronic device (102; 104; 800) to the electronic device.

According to an embodiment of the disclosure, the instructions, when executed by the at least one processor, cause the electronic device to provide information related to the profile transfer based on the user input.

According to an embodiment of the disclosure, the instructions, when executed by the at least one processor, cause the electronic device to obtain, from the external electronic device, information used for downloading a profile.

According to an embodiment of the disclosure, the information related to the profile transfer includes information indicating that the information related to the profile transfer is provided by the electronic device to download the profile.

In accordance with another aspect of the disclosure, an electronic device (102; 104; 800) is provided. The electronic device includes at least one communication circuit (190), at least one processor (120), and memory (130) storing instructions.

According to an embodiment of the disclosure, the instructions, when executed by the at least one processor, cause the electronic device to obtain information related to a profile transfer from the electronic device to an external electronic device (101).

According to an embodiment of the disclosure, the instructions, when executed by the at least one processor, cause the electronic device to provide at least one phone number of the electronic device based on obtainment of the information related to the profile transfer.

According to an embodiment of the disclosure, the instructions, when executed by the at least one processor, cause the electronic device to identify a user input related to a phone number which is a target for the profile transfer among the at least one phone number.

According to an embodiment of the disclosure, the instructions, when executed by the at least one processor, cause the electronic device to transmit a message requesting the profile transfer to a server (520) related to the profile transfer via the at least one communication circuit based on the user input.

According to an embodiment of the disclosure, the instructions, when executed by the at least one processor, cause the electronic device to receive information for downloading the profile from the server via the at least one communication circuit in response to the message.

According to an embodiment of the disclosure, the instructions, when executed by the at least one processor, cause the electronic device to provide the information for downloading the profile.

According to an embodiment of the disclosure, the information related to the profile transfer includes information indicating that the information related to the profile transfer is provided by the external electronic device to download the profile.

In accordance with another aspect of the disclosure, a method is provided. The method includes identifying a user input which triggers profile transfer from an external electronic device (102; 104; 800) to an electronic device (101).

According to an embodiment of the disclosure, the method includes providing information related to the profile transfer based on the user input.

According to an embodiment of the disclosure, the method includes obtaining, from the external electronic device, information for downloading a profile.

According to an embodiment of the disclosure, the information related to the profile transfer includes information indicating that the information related to the profile transfer is provided by the electronic device to download the profile.

In accordance with another aspect of the disclosure, a method is provided. The method includes obtaining information related to a profile transfer from an electronic device (102; 104; 800) to an external electronic device (101).

According to an embodiment of the disclosure, the method includes providing at least one phone number of the electronic device based on obtainment of the information related to the profile transfer.

According to an embodiment of the disclosure, the method includes identifying a user input related to a phone number which is a target for the profile transfer among the at least one phone number.

According to an embodiment of the disclosure, the method includes transmitting a message requesting the profile transfer to a server (520) related to the profile transfer based on the user input.

According to an embodiment of the disclosure, the method includes receiving information for downloading the profile from the server in response to the message.

According to an embodiment of the disclosure, the method includes providing the information for downloading the profile.

According to an embodiment of the disclosure, the information related to the profile transfer includes information indicating that the information related to the profile transfer is provided by the external electronic device to download the profile.

In accordance with another aspect of the disclosure, one or more non-transitory computer-readable storage media storing one or more computer programs are provided.

According to an embodiment of the disclosure, the one or more computer programs include computer-executable instructions that, when executed by one or more processors (120) of an electronic device (101), cause the electronic device to perform operations.

According to an embodiment of the disclosure, the operations include identifying a user input which triggers profile transfer from an external electronic device (102; 104; 800) to an electronic device (101).

According to an embodiment of the disclosure, the operations include providing information related to the profile transfer based on the user input.

According to an embodiment of the disclosure, the operations include obtaining, from the external electronic device, information for downloading a profile.

According to an embodiment of the disclosure, the information related to the profile transfer includes information indicating that the information related to the profile transfer is provided by the electronic device to download the profile.

In accordance with another aspect of the disclosure, one or more non-transitory computer-readable storage media storing one or more computer programs are provided.

According to an embodiment of the disclosure, the one or more computer programs include computer-executable instructions that, when executed by one or more processors (120) of an electronic device (102; 104; 800), cause the electronic device to perform operations.

According to an embodiment of the disclosure, the operations include obtaining information related to a profile transfer from the electronic device to an external electronic device (101).

According to an embodiment of the disclosure, the operations include providing at least one phone number of the electronic device based on obtainment of the information related to the profile transfer.

According to an embodiment of the disclosure, the operations include identifying a user input related to a phone number which is a target for the profile transfer among the at least one phone number.

According to an embodiment of the disclosure, the operations include transmitting a message requesting the profile transfer to a server (520) related to the profile transfer based on the user input.

According to an embodiment of the disclosure, the operations include receiving information for downloading the profile from the server in response to the message.

According to an embodiment of the disclosure, the operations include providing the information for downloading the profile.

According to an embodiment of the disclosure, the information related to the profile transfer includes information indicating that the information related to the profile transfer is provided by the external electronic device to download the profile.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1A is a block diagram illustrating an electronic device within a network environment according to an embodiment of the disclosure;

FIG. 1B is a diagram illustrating a network environment including an electronic device according to an embodiment of the disclosure;

FIG. 2 is a diagram for describing a system for providing an electronic device with a profile-based communication connection according to an embodiment of the disclosure;

FIG. 3 is a block diagram illustrating a structure of an electronic device according to an embodiment of the disclosure;

FIG. 4 is a diagram for describing an internal structure of an eUICC according to an embodiment of the disclosure;

FIG. 5 is a block diagram illustrating a network system for downloading a profile according to an embodiment of the disclosure;

FIG. 6 is a flowchart illustrating an operating process of an electronic device according to an embodiment of the disclosure;

FIG. 7 is a flowchart illustrating an operating process of an external electronic device according to an embodiment of the disclosure;

FIG. 8A is a signal flowchart illustrating a profile transferring process between electronic devices according to an embodiment of the disclosure;

FIG. 8B is a signal flowchart illustrating a profile transferring process between electronic devices according to an embodiment of the disclosure;

FIG. 9A is a diagram for describing screens displayed on an electronic device according to an embodiment of the disclosure;

FIG. 9B is a diagram for describing screens displayed on an electronic device according to an embodiment of the disclosure;

FIG. 10 is a signal flowchart illustrating a profile transferring process between electronic devices according to an embodiment of the disclosure;

FIG. 11A is a diagram for describing screens displayed on an electronic device according to an embodiment of the disclosure;

FIG. 11B is a diagram for describing screens displayed on an electronic device according to an embodiment of the disclosure;

FIG. 12A is a signal flowchart illustrating a profile transferring process between electronic devices according to an embodiment of the disclosure;

FIG. 12B is a signal flowchart illustrating a profile transferring process between electronic devices according to an embodiment of the disclosure;

FIG. 13A is a diagram for describing screens displayed on an electronic device according to an embodiment of the disclosure;

FIG. 13B is a diagram for describing screens displayed on an electronic device according to an embodiment of the disclosure;

FIG. 14A is a signal flowchart illustrating a profile transferring process between electronic devices according to an embodiment of the disclosure;

FIG. 14B is a signal flowchart illustrating a profile transferring process between electronic devices according to an embodiment of the disclosure;

FIG. 15A is a diagram for describing screens displayed on an electronic device according to an embodiment of the disclosure;

FIG. 15B is a diagram for describing screens displayed on an electronic device according to an embodiment of the disclosure; and

FIG. 15C is a diagram for describing screens displayed on an electronic device according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions will be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Alternatively, a singular expression used herein may include a plural expression unless they are definitely different in the context. As used herein, such an expression as “comprises” or “include”, or the like should not be interpreted to necessarily include all elements or all operations described in the specification, and should be interpreted to be allowed to exclude some of them or further include additional elements or operations.

Alternatively, the terms including an ordinal number, such as expressions “a first” and “a second” may be used to describe various elements, but the corresponding elements should not be limited by such terms. These terms are used merely to distinguish between one element and any other element. For example, a first element may be termed a second element, and similarly, a second element may be termed a first element without departing from the scope of the disclosure.

It should be understood that when an element is referred to as being “connected” or “coupled” to another element, it may be connected or coupled directly to the other element, or any other element may be interposer between them. In contrast, it should be understood that when an element is referred to as being “directly connected” or “directly coupled” to another element, there are no element interposed between them.

Hereinafter, an embodiment of the disclosure will be described in detail with reference to the accompanying drawings. Regardless of drawing signs, the same or like elements are provided with the same reference numeral, and a repeated description thereof will be omitted. Alternatively, in describing an embodiment of the disclosure, a detailed description of relevant known technologies will be omitted when it is determined that the description may make the subject matter of the disclosure unclear. Alternatively, it should be noted that the accompanying drawings are presented merely to help easy understanding of the technical idea of the disclosure, and should not be construed to limit the technical idea of the disclosure. The technical idea of the disclosure should be construed to cover all changes, equivalents, and alternatives, in addition to the drawings.

Hereinafter, an electronic device will be described in an embodiment of the disclosure, but the electronic device may be referred to as a terminal, a mobile station, a mobile equipment (ME), a user equipment (UE), a user terminal (UT), a subscriber station (SS), a wireless device, a handheld device, and an access terminal (AT). Alternatively, in an embodiment of the disclosure, the electronic device may be a device having a communication function such as, for example, a mobile phone, a personal digital assistant (PDA), a smart phone, a wireless MODEM, and a notebook.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

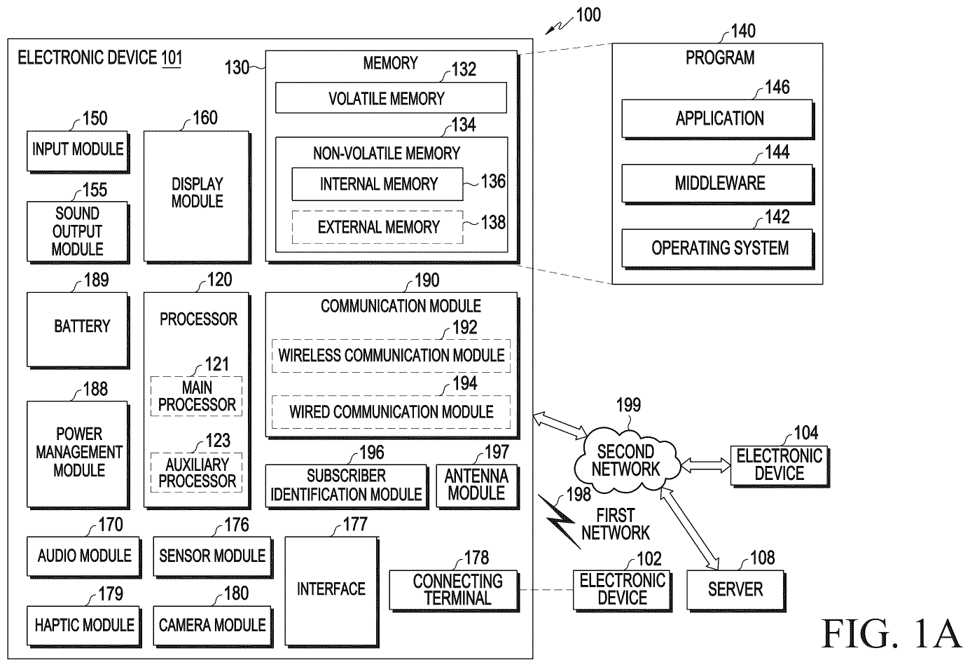

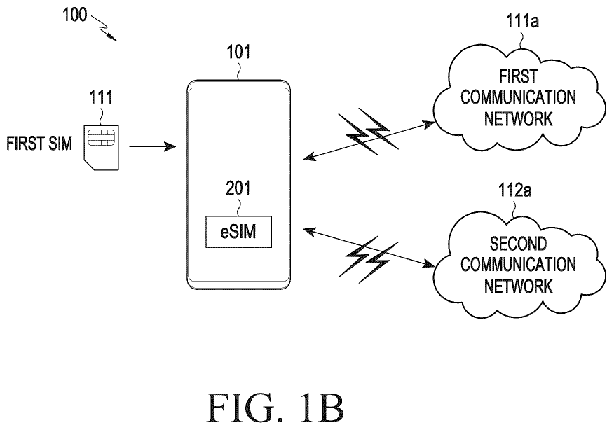

FIG. 1A is a block diagram illustrating an electronic device 101 in a network environment 100 according to an embodiment of the disclosure.

Referring to FIG. 1A, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence model is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5^{th} generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4^{th} generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to some embodiments, another component (e.g., a radio frequency integrated circuit (RFIC)) other than the radiating element may be additionally formed as part of the antenna module 197.

According to an embodiment, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to an embodiment may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that an embodiment of the disclosure and the terms used therein are not intended to limit the technological features set forth herein to a particular embodiment and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1^{st}” and “2^{nd},” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with an embodiment of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or two or more functions. For example, according to an embodiment, the module may be implemented in a form of an application-specific integrated circuit (ASIC).

An embodiment as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

FIG. 1B is a diagram illustrating a network environment 100 including an electronic device according to an embodiment of the disclosure.

Referring to FIG. 1B, a network according to an embodiment of the disclosure may include an electronic device 101 (e.g., an electronic device 101 in FIG. 1A), a first communication network 111a, and/or a second communication network 112a.

According to an embodiment, the electronic device 101 may operate as a dual SIM dual standby (DSDS) electronic device or a dual SIM dual active (dual SIM dual active: DSDA) electronic device which supports two subscriber identity modules (SIMs) in one device. For example, the electronic device 101 may include a first SIM 111 and an embedded SIM (eSIM) 201. The first SIM 111 may be a removable SIM (rSIM). For example, a SIM card may be equipped in the electronic device 101. Hereinafter, for convenience of a description, the SIM card will be referred to as a SIM. The electronic device 101 may include a slot (not shown) to accommodate the first SIM 111. According to an embodiment, although not separately shown in FIG. 1B, the electronic device 101 may accommodate two or more SIMs. In this case, the electronic device 101 may include a plurality of slots for accommodating a plurality of SIMs.

For example, the first SIM 111 may be a SIM subscribed to a communication provider of the first communication network 111a. The electronic device 101 may receive a wireless communication service by accessing the first communication network 111a using the first SIM 111. According to an embodiment, the electronic device 101 may include an eSIM 201. An eSIM may also be referred to as an embedded UICC (eUICC). The electronic device 101 may receive a wireless communication service by accessing the second communication network 112a using the eSIM 201. The first communication network 111a and the second communication network 112a may be provided by the same communication provider or by different communication providers.

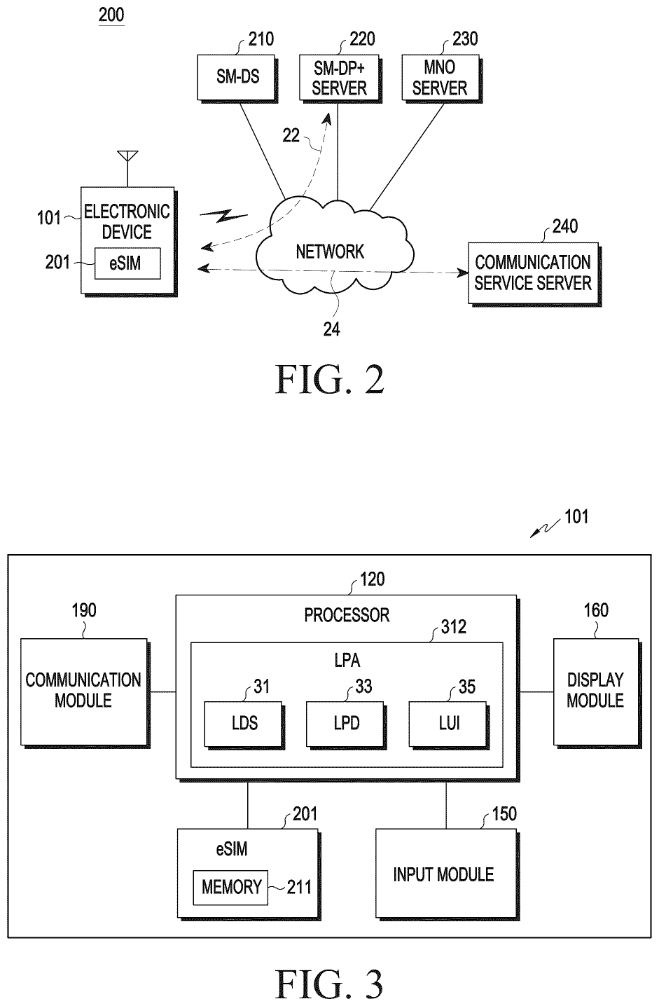

FIG. 2 is a diagram for describing a system for providing an electronic device with a profile-based communication connection according to an embodiment of the disclosure.

Referring to FIG. 2, according to an embodiment, a system 200 may include an electronic device 101, a subscription manager discovery server (SM-DS) 210, a subscription manager data preparation plus (SM-DP+) server 220, a mobile network operator (MNO) server 230, and a communication service server 240.

According to an embodiment, the electronic device 101 (e.g., an electronic device 101 in FIG. 1A or FIG. 1B) may include an eSIM 201. For convenience of a description, although not separately illustrated in FIG. 2, the electronic device 101 may include at least one slot capable of accommodating at least one rSIM. According to an embodiment, the electronic device 101 may include or accommodate N (here, N is a natural number) SIMs (e.g., eSIMs or rSIMs) and may perform a switching operation to use some of the N SIMs. In an embodiment, there may be no limitation to combining the N SIMs, and there may be also no limitation to a value of N.

According to an embodiment, the eSIM 201 may be provided integrally with the electronic device 101, or implemented to be accessible by the electronic device 101. According to an embodiment, the eSIM 201 may allow the electronic device 101 to perform an authenticating operation with the MNO server 230 using information (e.g., a profile including universal subscriber identity module (USIM) information) stored at the eSIM 201. According to an embodiment, the eSIM 201 may be called a SIM card in a global system for mobile communications (GSM) scheme or may be called a universal subscriber identity module (USIM) card in a wideband code division multiple access (WCDMA) scheme, a long-term evolution (LTE) scheme, and a new radio (NR) scheme. In addition to this, the eSIM 201 may be called various names according to communication schemes. For example, if a user of the electronic device 101 subscribes to a wireless communication service provided by the communication carrier, the electronic device 101 may use information (e.g., an international mobile subscriber identity (IMSI) value and a K value which is an encryption key for authentication) within the eSIM 201 to perform a suitable authenticating process with the MNO server 230 at which the same IMSI value and encryption key are stored. If authentication via the authenticating process is successful, the electronic device 101 may use the wireless communication service. In an embodiment, the authenticating process may be based on an authentication scheme. The authentication scheme may be an extensible authentication protocol authentication and key agreement (EAP-AKA) scheme, an open identification (OPEN ID) scheme, or a short message service one time password (SMS-OTP) scheme. The EAP-AKA scheme may be an authentication scheme using a physical SIM (e.g., a USIM) or an eSIM profile, and may follow RFC 4187, but may not be limited thereto. The OPEN ID scheme may be an authentication scheme using an ID/password on a web page of the communication provider. The SMS-OTP scheme may be an OTP scheme using an SMS.

According to an embodiment, the eSIM 201 may be manufactured in a form of a dedicated card for a specific communication provider according to a request of the corresponding communication provider, and may be preloaded with authentication information (e.g., a USIM application and a subscriber ID (e.g., an IMSI)), and an encryption key (e.g., a known K value or Ki value) for a network access of the corresponding communication provider. An application (or information) within the eSIM 201 may be installed, modified, deleted, or updated using various technologies such as an over the air (OTA) if necessary.

According to an embodiment, the eSIM 201 may download and/or store information for providing a communication service, in the form of a profile. According to an embodiment, the profile may be installed or stored in a manufacturing process of the eSIM 201 or may be downloaded by the electronic device 101 with the OTA scheme and installed or stored in the eSIM 201. For example, the profile may include a provisioning profile and an operational profile. Even though the provisioning profile is not installed, the electronic device 101 may download the operational profile through a short-range connection which is based on a wireless fidelity (Wi-Fi) scheme or an Internet connection, and those skilled in the art will understand that the provisioning profile does not necessarily need to be installed on the electronic device 101. For example, the operational profile may be a profile including subscriber identification information of the user of the electronic device 101, and the provisioning profile may include information (hereinafter, it will be also referred to as “first information”) for downloading subscriber identity information or a profile (hereinafter, it will be also referred to as a “first operational profile”) including subscriber identity information (hereinafter, it will be also referred to as “first subscriber identity information”) in the electronic device 101. The electronic device 101 may download the first operational profile based on the first information in the provisioning profile within the eSIM 201.

According to an embodiment, the electronic device 101 may receive a communication service using subscriber identity information (hereinafter, it will be also referred to as “second subscriber identity information”) in an operational profile (hereinafter, it will be also referred to as a “second operational profile”) installed or stored in the eSIM 201. For example, the profile including subscriber identification information may be a SIM profile.

According to an embodiment, the operational profile may further include, in addition to the subscriber identification information, at least one of network access authentication information of the subscriber, a phone book of the subscriber, personal information (e.g., a short message service (SMS)) of the subscriber, a subscribed communication provider name, a usable service, usable data amount, fee or a service provision speed, and/or information related to subscriber authentication and traffic security key generation required upon accessing a wireless communication network (e.g., a GSM communication network, a WCDMA communication network, an LTE communication network, or an NR communication network).

According to an embodiment, the first information used for downloading data (e.g., the first operational profile) including the first subscriber identity information may include communication session information for a first communication connection designated for downloading the first operational profile. For example, the communication session information may include access information for the SM-DS 210 for downloading the first operational profile and/or communication provider network information usable for an access to the SM-DS 210.

According to an embodiment, the SM-DS 210 may provide the electronic device 101 with an address of the SM-DP+ server 220 for downloading the first operational profile based on the provisioning profile.

According to an embodiment, the SM-DP+ server 220 may be a profile providing server, an off-card entity of profile domain, a profile encrypting server, a profile generating server, a profile provisioner, or a profile provider. The SM-DP+ server 220 may establish a first communication connection 22 with the electronic device 101 through a wireless communication network based on a first communication connection request based on the provisioning profile from the electronic device 101, and may provide the electronic device 101 with the first operational profile through the first communication connection 22.

According to an embodiment, the wireless communication network may be a specific node of the wireless communication network. For example, the wireless communication network may be a base station, a subscriber information management node, and/or a mobility management node of the wireless communication network. According to an embodiment, the wireless communication network may include a home position register (HLR) and/or authentication center (AuC) server which is accessed by the electronic device 101 to perform a subscriber authenticating function. Upon succeeding in subscriber authentication, the electronic device 101 may access the communication service server 240 to receive various communication services, such as a voice communication or data communication.

According to an embodiment, the MNO server 230 may be a server associated with a mobile communication network operator. According to an embodiment, the MNO server 230 may request the SM-DS+ server 220 to prepare for at least one profile (or profile package) (e.g., the first operational profile) associated with at least one subscriber identity information (e.g., the first subscriber identity information), and may transmit information associated with the first operational profile to the SM-DS+ server 220. According to an embodiment, the MNO server 230 may transmit a signal for updating and managing the first operational profile to the SM-DS+ server 220. The MNO server 230 may allow a second communication connection 24 between the electronic device 101 and the communication service server 240 through the second operational profile installed in the eSIM 201 of the electronic device 101.

According to an embodiment, the communication service server 240 may be a server providing communication services. According to an embodiment, the communication service may be a service associated with transmission and/or reception of data through a wireless communication network. According to an embodiment, the communication service may include a service associated with transmission and/or reception of another profile (or data) not including subscriber identity information other than downloading the operational profile (e.g., the first operational profile including the first subscriber identity information). For example, the communication service server 240 may include various service servers associated with data transmission and reception, such as a server associated with each of various applications, a push server, a search server, and/or a market server. A communication service by the communication service server 240 may include various services, such as data transmission/reception by an application, notification reception, push message reception, link reception and access, and/or service request.

According to an embodiment, upon requesting a service associated with transmission and/or reception of a profile (or data) not including subscriber identification information, the electronic device 101 may establish the second communication connection 24 with the communication service server 240 based on the second operational profile.

According to an embodiment, the SM-DS 210, the SM-DP+ server 220, the MNO server 230, and/or the communication service server 240 are just an example in which an entity for performing a corresponding function is implemented in a form of a server, and may be referred to as other names, and each of the SM-DS 210, the SM-DP+ server 220, the MNO server 230, and/or the communication service server 240 may be implemented with one or a plurality of servers. Some or all of the SM-DS 210, the SM-DP+ server 220, the MNO server 230, and/or the communication service server 240 may be implemented as a single integrated server.

FIG. 3 is a block diagram illustrating a structure of an electronic device according to an embodiment of the disclosure.

Referring to FIG. 3, an electronic device 101 (e.g., an electronic device 101 in FIG. 1A, 1B, or 2) according to an embodiment may include a processor 120 (e.g., a processor 120 in FIG. 1A), an eSIM 201 (e.g., a subscriber identification module 196 in FIG. 1A or an eSIM 201 in FIG. 2), a communication module 190 (e.g., a communication module 190 in FIG. 1A), a display module 160 (e.g., a display module 160 in FIG. 1A), and an input module 150 (e.g., an input module 150 in FIG. 1A). For convenience of a description, although not separately illustrated, the electronic device 101 may include two or more slots capable of accommodating two or more rSIMs.

According to an embodiment, the processor 120 (e.g., a processor 120 in FIG. 1A) may include one or more processors (e.g., a main processor 121 and an auxiliary processor 123 in FIG. 1A, or an application processor and a communication processor), and include a local profile assistant (LPA) 312 (e.g., an LPA device (LPAd)) according to an embodiment. According to an embodiment, if the processor 120 includes a plurality of processors, a portion of the LPA 312 may be included in some of the plurality of processors, and another portion of the LPA 312 may be included in others of the plurality of processors. According to an embodiment, the LPA 312 may be included in the eSIM 201 and, in this case, the LPA 312 may be referred to as an LPAe (or eUICC).

According to an embodiment, the LPA 312 may perform a communication with a server to support an operation of downloading, installing, and managing a profile of the eSIM 201, or may perform an operation of providing a user interface (UI) required for the operation of downloading, installing, and managing the profile. The LPA 312 may include local discovery services (LDS) 31, local profile download (LPD) 33, and local user interface (LUI) 35 operations within the electronic device 101.

According to an embodiment, the LDS 31 may perform an operation of performing a communication with an SM-DS 210, and an operation of receiving an address of an SM-DS+ server 220 capable of downloading an operational profile based on a provisioning profile from the SM-DS 210.

According to an embodiment, the LPD 33 may perform an operation of establishing a first communication connection 22 with the SM-DS+ server 220 through a wireless communication network based on the address of the SM-DS+ server 220 and receiving a first operational profile from the SM-DS+ server 220 through the first communication connection 22. According to an embodiment, the LPD 33 may support an operation of downloading, enabling, disabling, and deleting a profile, or a profile policy rule (PPR) download operation, started by a network, and may support an operation of enabling, disabling, and deleting a profile, or an eUICC reset operation by the electronic device 101.

According to an embodiment, the LUI 35 may perform an operation of providing various UIs upon downloading the operational profile. According to an embodiment, the LUI 35 may support data exchange between the user and the LDS 31 and the LPD 33 and may include a UI for transferring a user's input to the LDS 31 or the LPD 33.

According to an embodiment, the processor 120 may perform a communication service based on information stored in the eSIM 201 using (or by executing) the LPA 312. For example, the processor 120 may establish a first communication connection to download a profile (e.g., the first operational profile) including first subscriber identity information, with the SM-DS+ server 220 through the communication module 190 based on the provisioning profile stored in the eSIM 201, using the LPA 312. Upon request of transmission and/or reception of data and/or a profile not including subscriber identity information while establishing the first communication connection using the LPA 312, the processor 120 may release the first communication connection and establish a second communication connection based on second subscriber identity information to perform an operation of transmitting and/or receiving the data and/or profile not including the subscriber identity information.

According to an embodiment, the eSIM 201 may include one or a plurality of profiles, as information for receiving a communication service. A profile may mean a packaging, in a form of software, of at least one of an application, a file system, or an authentication key value stored in the eSIM 201. For example, the profile may include a provisioning profile and an operational profile. The operational profile may include subscriber identification information, and may further include, in addition to the subscriber identification information, at least one of network access authentication information of the subscriber, a phone book of the subscriber, personal information (e.g., an SMS) of the subscriber, a subscribed communication provider name, a usable service, usable data amount, fee or a service provision speed, and/or information related to subscriber authentication and traffic security key generation required upon accessing a wireless communication network such as a GSM communication network, a WCDMA communication network, an LTE communication network, or an NR communication network). According to an embodiment, the operational profile may include a SIM profile. For example, the SIM profile may include an SIM file system (a master file (MF), a dedicated file (DF), and an elementary file (EF)), and subscriber identification information (e.g., an IMSI value) may be stored in the elementary file.

According to an embodiment, the provisioning profile may be a profile including first information for downloading the first operational profile in the electronic device 101. For example, the first information may include communication session information for the first communication connection designated for downloading the first operational profile. For example, the communication session information may include access information for an SM-DS (e.g., an SM-DS 210 in FIG. 2) for downloading the first operational profile, and may include communication provider network information usable for an access to the SM-DS.

According to an embodiment, the communication module 190 (e.g., a communication module 190 in FIG. 1A) may perform a first communication based on the provisioning profile or a second communication based on the second operational profile. At least one screen associated with the first communication based on the provisioning profile or the second communication based on the second operational profile may be displayed on the display device 160.

In FIG. 3, although a case that the LPA 312 is included in the processor 120 has been described as an example, at least some functions of the LPA 312 may be performed by the processor 120, or a separate LPA 312 may be operated in conjunction with the processor 120. For example, the LPA 312 may be included in a program (e.g., a program 140 in FIG. 1A) and may be loaded onto the processor 120 and executed, and if the LPA 312 is loaded on the processor 120 and executed, it may be understood as an operation of the processor 120. According to an embodiment, function modules (e.g., the LDS 31, the LPD 33, and/or the LUI 35) included in the LPA 312 are illustratively separated, may be expressed in other functional modules, and may not be limited to the corresponding form. According to an embodiment, the LPA 312 may be included within the eSIM 201.

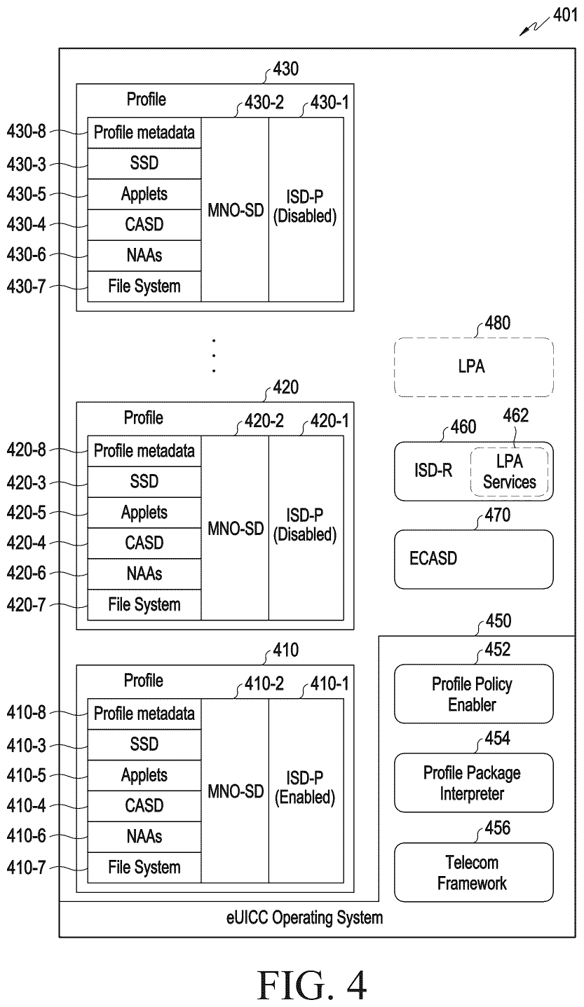

FIG. 4 is a diagram for describing an internal structure of an eUICC according to an embodiment of the disclosure.

Referring to FIG. 4, an eUICC 401 (e.g., a subscriber identification module in FIG. 1A, or an eSIM 201 in FIG. 1B, 2 or 3) may have a form such as a card or chip, and at least one profile (e.g., a profile 410, a profile 420, or a profile 430) with a software form may be installed in the eUICC 401. According to an embodiment, each of the profiles 410, 420, and 430 may be a provisioning profile or an operational profile. The profiles 410, 420, and 430 may operate on an eUICC operating system (OS) 450. Each of the profiles 410, 420, and 430 may be enabled or disabled by a processor or an LPA (e.g., an LPA 312 in FIG. 3 or an LPA 480 in FIG. 4). In FIG. 4, it will be assumed that one profile 410 may be in an enabled state, and the remaining profiles 420 and 430 may be in a disabled state. According to an embodiment, two or more profiles may be enabled within the eUICC 401.

According to an embodiment, the eUICC OS 450 of the eUICC 401 may include a profile policy enabler 452, a profile package interpreter 454, and a telecom framework 456. According to an embodiment, the profile policy enabler 452 may manage a policy rule (e.g., a profile policy rule (PPR)) for each of the profiles 410, 420, and 430. According to an embodiment, the profile package interpreter 454 may unpackage a profile package received from an SM-DP+ server (e.g., an SM-DP+ server 220 in FIG. 2), in a form which may be installed in the eUICC 401. According to an embodiment, the telecom framework 456 may perform a function associated with a communication of applications within the eUICC 401. According to an embodiment, the eUICC 401 may include an issuer security domain root (ISD-R) 460, and an eUICC controlling authority security domain (ECASD) 470. According to an embodiment, the ISD-R 460 may manage the profiles 410, 420, and 430 installed in the eUICC 401. For example, the ISD-R 460 may include LPA services 462, and the LPA services 462 may manage the profiles 410, 420, and 430 installed in the eUICC 401 through an interface with the processor or the LPA (e.g., the LPA 312 in FIG. 3 or the LPA 480 in FIG. 4). According to an embodiment, the ECASD 470 may perform security processing on the profiles 410, 420, and 430 installed in the eUICC 401.

According to an embodiment, each of the profiles 410, 420, and 430 may include an ISD-P 410-1, 420-1 or 430-1, an MNO-SD 410-2, 420-2, or 430-2, a supplementary security domain (SSD) 410-3, 420-3, or 430-3, a controlling authority security domain (CASD) 410-4, 420-4, or 430-4, Applets 410-5, 420-5, or 430-5, network access applications (NAAs) 410-6, 420-6 or 430-6, a file system 410-7, 420-7, or 430-7, or profile metadata 410-8, 420-8, or 430-8.

According to an embodiment, the ISD-P 410-1, 420-1, or 430-1 may include information for decoding and interpretation of the profile package, and may be used to unpackage and install the profile package received from the SM-DP+ in cooperation with the profile package interpreter 454.

According to an embodiment, the MNO-SD 410-2, 420-2, or 430-2 may include an OTA key of an MNO, and may include information for providing a secure OTA channel capable of communicating with the MNO.

According to an embodiment, the SSD 410-3, 420-3, or 430-3 and the CASD 410-4, 420-4, or 430-4 may include information for performing security processing on a profile.

According to an embodiment, the Applets 410-5, 420-5, or 430-5 may include various application information associated with a user of the profile.

According to an embodiment, the NAAs 410-6, 420-6, or 430-6 may include application information which allows the profile to access a network.

According to an embodiment, the file system 410-7, 420-7, or 430-7 may include a file system associated with each information of the profile.

According to an embodiment, the profile metadata 410-8, 420-8, or 430-8 may also be referred to as a profile record, and may include metadata information about the profile in a text form. The metadata information may include at least one of an integrated circuit card ID (ICCID) of the profile, a profile name, a name of an MNO providing the profile, a user's profile nickname, an icon, a profile class, notification configuration information, profile owner information, or a PPR.

According to an embodiment, the ICCID of the profile, as a profile identifier, may indicate a unique identifier of each profile. The name of the profile may include a name of each profile. The name of the MNO providing the profile may include a name of a communication provider which provides the profile. The user's profile nickname may include a profile nickname specified by the user. The icon may include an icon corresponding to the profile. The profile class may include information indicating whether a type of the profile is a provisioning profile or an operational profile. The notification configuration information may include an address of a server (e.g., an SM-DP+ server 220 in FIG. 2) to receive notifications. The profile owner information may include at least one of a mobile country code (MCC), a mobile network code (MNC), or group identifier (GID) 1 or 2 information associated with a profile owner. For example, the MCC may be a code for identifying a country, and the MNC may be a code for identifying a mobile communication provider. The GID 1 or 2 may be code area information for identifying a group or an area to which the profile belongs. Area information may include information about a group including a plurality of countries. The PPR may include policy rule information for managing the profile.

According to an embodiment, the electronic device (e.g., an electronic device 101 in FIG. 1A, 1B, 2, or 3) may identify whether each of the profiles 410, 420, and 430 is a provisioning profile or an operational profile based on the profile class information of the profile metadata 410-8, 420-8, or 430-8 included in each of the profiles 410, 420, and 430 included in the eUICC 401 and enable or disable each of the provisioning profile or the operational profile via the LPA 480 (e.g., an LPA 312 in FIG. 3).

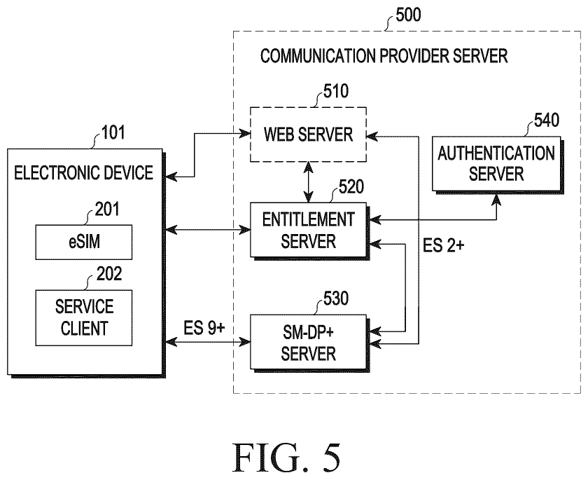

FIG. 5 is a block diagram illustrating a network system for downloading a profile according to an embodiment of the disclosure.

Referring to FIG. 5, a network system according to an embodiment may include an electronic device 101 (e.g., an electronic device 101 in FIG. 1A, 1B, 2, or 3), and a communication provider server 500.

The communication provider server 500 may include at least one of an entitlement server (or an entitlement configuration server) 520, an SM-DP+ server 530 (e.g., an SM-DP+ server 220 in FIG. 2, or an authentication server 540. According to an embodiment, the communication provider server 500 may include a web server 510 or may not include the web server 510. For example, at least one of the web server 510, the entitlement server 520, the SM-DP+ server 530, or the authentication server 540 may be included in the communication provider server 500 managed by a communication provider. According to an embodiment, the web server 510 and the entitlement server 520 may be servers managed by the same communication provider or different communication providers. According to an embodiment, the entitlement server 520 and the SM-DP+ server 530 may be servers managed by the same communication provider or different communication providers.

An eSIM 201 (e.g., a subscriber identification module 196 in FIG. 1A, an eSIM 201 in FIG. 1B, 2, or 3, or an eUICC 401 in FIG. 4) may be inserted into the electronic device 101 or the eSIM 201 may be embedded in the electronic device 101. A profile may be downloaded and installed in the eSIM 201. A service client 202 may be installed in the electronic device 101 for a communication with the communication provider server 500 according to an embodiment to be described later. In an embodiment, the electronic device 101 may include a physical SIM without including the eSIM 201, and a profile may be downloaded and installed in the physical SIM.

According to an embodiment, the electronic device 101 may access the entitlement server 520 via the service client 202 and access the web server 510 via the accessed entitlement server 520. For example, if the electronic device 101 accesses the entitlement server 520, the entitlement server 520 may perform an authentication operation and an eligibility check operation for the electronic device 101 or a user of the electronic device 101 via the authentication server 540. If the authentication operation and the eligibility check operation for the electronic device 101 or the user of the electronic device 101 are successful (for example, if authentication for the electronic device 101 or the user of the electronic device 101 is successful, and the electronic device 101 or the user of the electronic device 101 is eligible), the entitlement server 520 may transmit, to the electronic device 101, information required for an access to the web server 510.

The electronic device 101 may access the web server 510 using the information required for the access to the web server 510 received via the entitlement server 520. According to an embodiment, the electronic device 101 may request subscription, opening, or line transfer (or subscription transfer or profile transfer) via a web page provided by the web server 510. According to an embodiment, the electronic device 101 may request the subscription, the opening, or the line transfer via the entitlement server 520 without the web server 510. For example, if the communication provider server 500 does not include the web server 510, or if the communication provider server 500 includes the web server 510, and does not provide information related to the web server 510 (for example, an address of the web server 510)(for example, if a web service or a web page is not provided via the web server 510), the electronic device 101 may request the subscription, the opening, or the line transfer via the entitlement server 520. According to an embodiment, the web server 510 may provide a UI or a web page for the entitlement server 520. For example, the electronic device 101 may request the subscription, the opening, or the line transfer via the web page provided from the web server 510. According to an embodiment, the entitlement server 520 may provide line management and creation, service control, and status information. For example, the entitlement server 520 may include an entitlement server or an entitlement configuration server specified in GSM association (GSMA) standard document TS. 43 (e.g., TS. 43, Version 9). In the standard document TS. 43 (e.g., TS. 43, Version 9), the term “entitlement” may include meaning of applicability, availability, or status of a service required before providing a service (e.g., a communication service) to the user of the electronic device 101. For example, the entitlement server 520 may perform a function of delivering information (e.g., profile download information or profile download-related information) related to a profile provided to the electronic device 101. In the description to be described later, profile information may include information related to a profile, and may also be referred to as profile download information or profile download-related information for convenience of a description. The entitlement server 520 may include a discovery and push function (DPF), an SM-DS, subscription manager secure routing (SM-SR), subscription manager secure routing plus (SM-SR+), an off-card entity of eUICC Profile Manager or a profile management credentials holder (PMC holder), or an eUICC manager (EM), but may not be limited thereto.

According to an embodiment, the SM-DP+ server 530 may perform a function of managing and downloading a profile. For example, the SM-DP+ server 530 may include, in addition to SM-DP+, at least one of subscription manager data preparation (SM-DP), an off-card entity of Profile Domain, a profile encrypting server, a profile generating server, a profile provisioner (PP), a profile provider, or a profile provisioning credentials holder (PPC holder), but may not be limited thereto.

According to an embodiment of the disclosure, an electronic device (101) may include at least one communication circuit (190), at least one processor (120), and memory (130) storing instructions.

According to an embodiment of the disclosure, the instructions, when executed by the at least one processor, may cause the electronic device to identify a user input which triggers profile transfer from an external electronic device (102; 104; 800) to the electronic device.

According to an embodiment of the disclosure, the instructions, when executed by the at least one processor, may cause the electronic device to provide information related to the profile transfer based on the user input.

According to an embodiment of the disclosure, the instructions, when executed by the at least one processor, may cause the electronic device to obtain, from the external electronic device, information used for downloading a profile.

According to an embodiment of the disclosure, the information related to the profile transfer may include information indicating that the information related to the profile transfer is provided by the electronic device to download the profile.

According to an embodiment of the disclosure, the instructions, when executed by the at least one processor, may cause the electronic device to download the profile from a server (220; 530) related to the profile transfer via the at least one communication circuit, based on the information used for downloading the profile.

According to an embodiment of the disclosure, the information used for downloading the profile may include an address of the server.

According to an embodiment of the disclosure, the information related to the profile transfer may include a prefix including a set string.

According to an embodiment of the disclosure, the information related to the profile transfer may include device information of the electronic device.

According to an embodiment of the disclosure, the device information may include at least one of an international mobile equipment identity (IMEI), an embedded universal integrated circuit card (eUICC) identifier (ID) (eUICC ID: EID), a model name, or a serial number of the electronic device.

According to an embodiment of the disclosure, the information related to the profile transfer may be provided in a form of a quick response (QR) code.

According to an embodiment of the disclosure, the information used for downloading the profile may be provided in a form of a quick response (QR) code.

According to an embodiment of the disclosure, an electronic device (102; 104; 800) may include at least one communication circuit (190), at least one processor (120), and memory (130) storing instructions.

According to an embodiment of the disclosure, the instructions, when executed by the at least one processor, may cause the electronic device to obtain information related to profile transfer from the electronic device to an external electronic device (101).

According to an embodiment of the disclosure, the instructions, when executed by the at least one processor, may cause the electronic device to provide at least one phone number of the electronic device based on obtainment of the information related to the profile transfer.

According to an embodiment of the disclosure, the instructions, when executed by the at least one processor, may cause the electronic device to identify a user input related to a phone number which is a target for the profile transfer among the at least one phone number.

According to an embodiment of the disclosure, the instructions, when executed by the at least one processor, may cause the electronic device to transmit a message requesting the profile transfer to a server (520) related to the profile transfer via the at least one communication circuit based on the user input.

According to an embodiment of the disclosure, the instructions, when executed by the at least one processor, may cause the electronic device to receive information used for downloading the profile from the server via the at least one communication circuit in response to the message.

According to an embodiment of the disclosure, the instructions, when executed by the at least one processor, may cause the electronic device to provide the information used for downloading the profile.

According to an embodiment of the disclosure, the information related to the profile transfer may include information indicating that the information related to the profile transfer is provided by the external electronic device to download the profile.

According to an embodiment of the disclosure, the information used for downloading the profile may include an address of another server (220; 530) related to the profile transfer.

According to an embodiment of the disclosure, the information related to the profile transfer may include a prefix including a set string.

According to an embodiment of the disclosure, the information related to the profile transfer may include device information of the external.

According to an embodiment of the disclosure, the device information may include at least one of an international mobile equipment identity (IMEI), an embedded universal integrated circuit card (eUICC) identifier (ID) (eUICC ID: EID), a model name, or a serial number of the external electronic device.

According to an embodiment of the disclosure, the information related to the profile transfer may be provided in a form of a quick response (QR) code.

According to an embodiment of the disclosure, the information used for downloading the profile may be provided in a form of a quick response (QR) code.

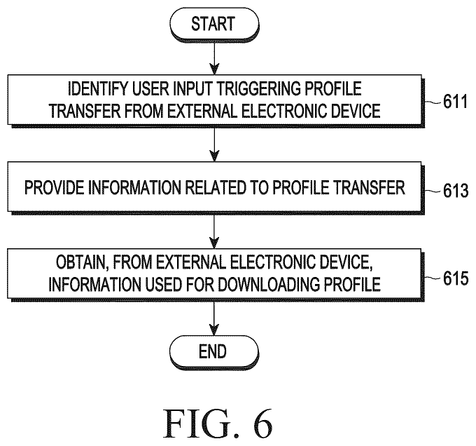

FIG. 6 is a flowchart illustrating an operating process of an electronic device according to an embodiment of the disclosure.

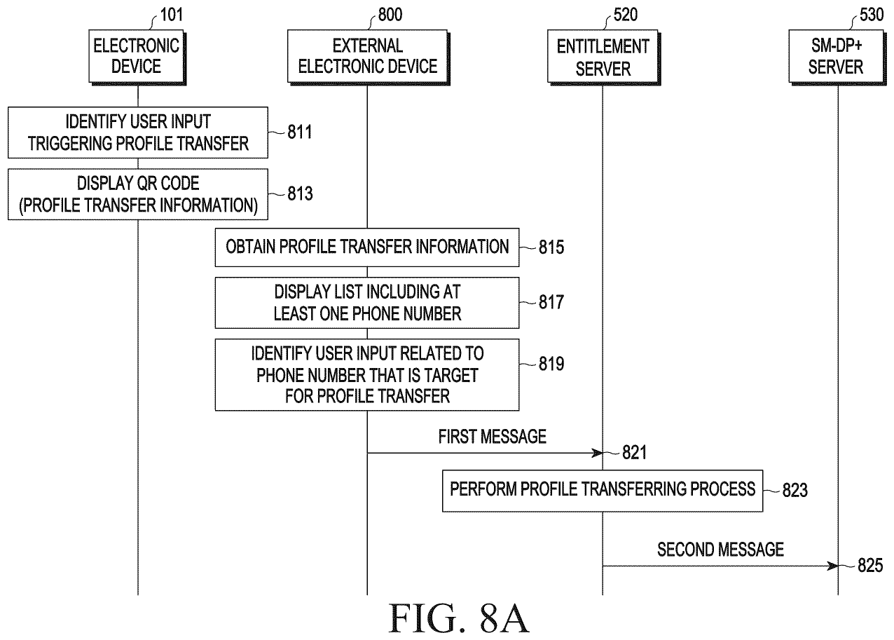

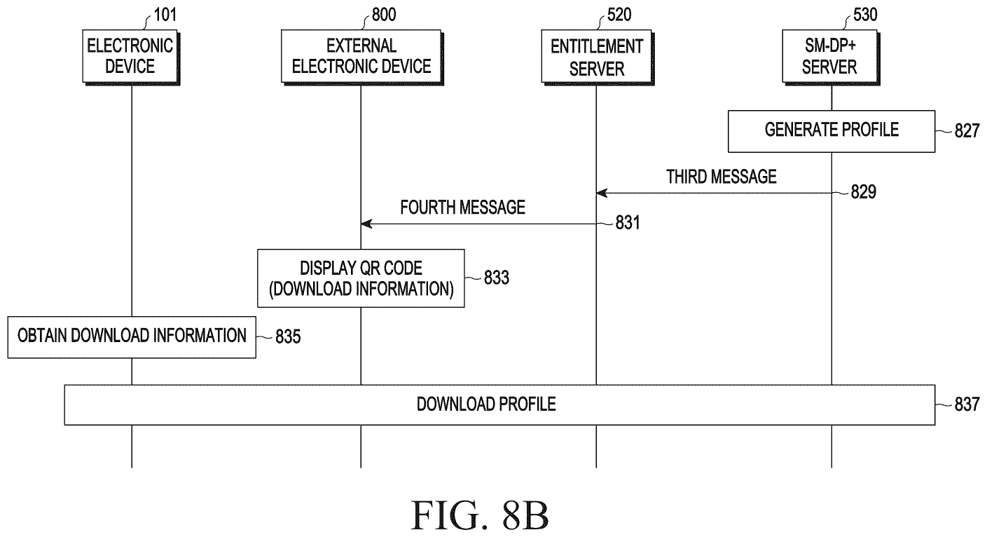

Referring to FIG. 6, in operation 611, an electronic device (e.g., an electronic device 101 in FIG. 1A, 1B, 2, 3, or 5) (e.g., a processor 120 in FIG. 1A or 3) may identify a user input which triggers profile transfer from an external electronic device (e.g., an electronic device 102 or an electronic device 104 in FIG. 1A, or an external electronic device 800 in FIG. 8A, 8B, 10, 12A, 12B, 14A, or 14B) to the electronic device. In an embodiment, the electronic device may identify a user input which triggers the profile transfer between electronic devices (e.g., a user input selecting the profile transfer between the electronic devices). For example, the electronic device may output (e.g., display) a user interface (UI) for selecting the profile transfer between the electronic devices (e.g., a profile transfer menu between electronic devices), and identify the user input via the UI. The UI may include information indicating a purpose of selecting to transfer a profile of the external electronic device to the electronic device, or information indicating a purpose of selecting to transfer the profile (or subscription or line) from the external electronic device to the electronic device for intuitive recognition by a user.

The electronic device, which identifies the user input which triggers the profile transfer from the external electronic device to the electronic device, may provide information related to the profile transfer in operation 613. In an embodiment, the information related to profile transfer may be provided in a form of a quick response (QR) code. In an embodiment of the disclosure, a case that the information related to the profile transfer is provided in the form of the QR code has been described as an example, however, the information related to the profile transfer may be provided in various forms such as a barcode, a text, and/or an image. If the information related to the profile transfer is provided in the various forms such as the barcode, the text, and/or the image, the information related to the profile transfer may be implemented similarly to or substantially the same as the information related to the profile transfer which is implemented in the form of the QR code. Displaying the QR code may be an example of providing the information related to the profile transfer between the electronic devices. In an embodiment, a set security scheme such as raw data and/or hashing may be applied to the QR code. By providing the information related to the profile transfer in the form of the QR code, a separate wireless connection (e.g., a wireless connection based on a short-range wireless communication scheme such as a Bluetooth scheme, a Wi-Fi scheme, a ultra wide band (UWB) scheme, and/or a near field communication (NFC) scheme, or a wireless connection based on a cellular communication scheme such as an LTE scheme, an LTE-A scheme, and/or an NR scheme) may not be required between the electronic devices for the profile transfer between the electronic devices. In an embodiment, the information related to the profile transfer may include information indicating that the information related to the profile transfer is provided by the electronic device to download the profile. In an embodiment, the information related to the profile transfer may include a prefix including a set string. In an embodiment, the information related to the profile transfer may include device information of the electronic device. In an embodiment, the device information may include at least one of an international mobile equipment identity (IMEI), an embedded universal integrated circuit card (eUICC) identifier (ID) (eUICC ID: EID), a model name, or a serial number of the electronic device.

The electronic device, which provides the information related to the profile transfer, may obtain, from the external electronic device, information used for downloading the profile in operation 615. In an embodiment, the information used for downloading the profile may include an address of a server (e.g., an SM-DP+ server 220 in FIG. 2, or an SM-DP+ server 530 in FIG. 5, 8A, 8B, 10, 12A, 12B, 14A, or 14B) related to the profile transfer. In an embodiment, the information used for downloading the profile may be provided in a form of a quick response (QR) code.

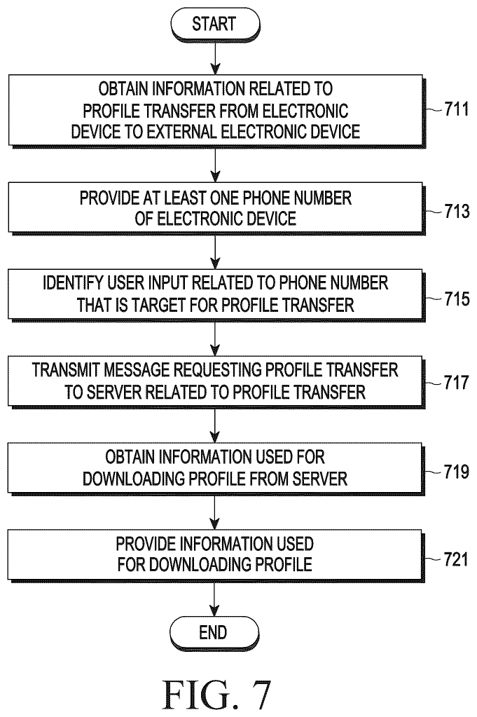

FIG. 7 is a flowchart illustrating an operating process of an external electronic device according to an embodiment of the disclosure.

Referring to FIG. 7, in operation 711, an electronic device (e.g., an electronic device 102 or an electronic device 104 in FIG. 1A, or an external electronic device 800 in FIG. 8A, 8B, 10, 12A, 12B, 14A, or 14B)(e.g., a processor 120 in FIG. 1a or 3) may obtain information related to profile transfer from the electronic device to an external electronic device (e.g., an electronic device 101 in FIG. 1A, 1B, 2, 3, or 5). In an embodiment, the information related to the profile transfer may include information indicating that the information related to the profile transfer is provided by the external electronic device to download a profile. In an embodiment, the information related to the profile transfer may include a prefix including a set string. In an embodiment, the information related to the profile transfer may include device information of the external electronic device. The device information may include at least one of an international mobile equipment identity (IMEI), an embedded universal integrated circuit card (eUICC) identifier (ID) (eUICC ID: EID), a model name, or a serial number of the external electronic device.

The electronic device, which obtains the information related to the profile transfer, may provide at least one phone number of the electronic device in operation 713. In an embodiment, the electronic device may provide (for example, display) at least one phone number in a form of a list in order to perform a profile transferring process. In an embodiment, the phone number of the electronic device may include a phone number corresponding to a physical SIM (pSIM) and/or a phone number corresponding to an eSIM. The electronic device may have a plurality of phone numbers. In an embodiment, the electronic device may include only phone numbers for which profile transfer may be possible in the list, or may mark phone numbers for which profile transfer may be impossible as unselectable to include them in the list.

The electronic device, which provides the at least one phone number of the electronic device, may identify a user input related to a phone number which is a target for the profile transfer among the at least one phone number in operation 715.

The electronic device, which identifies the user input related to the phone number which is the target for the profile transfer among the at least one phone number, may transmit a message requesting the profile transfer to a server (e.g., an entitlement server 520) related to the profile transfer via at least one communication circuit (e.g., a communication module 190 in FIG. 1A) in operation 717.

The electronic device, which transmits the message requesting the profile transfer to the server related to the profile transfer, may receive (for example, may obtain) information used for downloading the profile from the server via the at least one communication circuit in response to the message in operation 719. In an embodiment, the information used for downloading the profile may include an address of another server (e.g., an SM-DP+ server 220 in FIG. 2, or an SM-DP+ server 530 in FIG. 5, 8A, 8B, 10, 12A, 12B, 14A, or 14B) related to the profile transfer.

The electronic device, which receives the information used for downloading the profile from the server, may provide the information used for downloading the profile in operation 721. In an embodiment, the information used for downloading the profile may be provided in a form of a quick response (QR) code.

FIG. 8A is a signal flowchart illustrating a profile transferring process between electronic devices according to an embodiment of the disclosure.

FIG. 8B is a signal flowchart illustrating a profile transferring process between electronic devices according to an embodiment of the disclosure.

A profile transferring process between electronic devices illustrated in FIGS. 8a and 8b may be a profile transferring process between electronic devices in a case that an electronic device 101 (e.g., an electronic device 101 in FIG. 1A, 1B, 2, 3, or 5), which is a new electronic device, triggers profile transfer between the electronic device 101 and an external electronic device 800 (e.g., an electronic device 102 or an electronic device 104 in FIG. 1A) which is an existing electronic device. In an embodiment, the new electronic device may be an electronic device which will download a profile, and the existing electronic device may be an electronic device in which the profile has already been downloaded, or an electronic device in which a pSIM has been inserted. In an embodiment, the profile transferring process may be a process of transferring subscription or a line (or a number or a line) between the electronic devices. In an embodiment, the subscription may describe a commercial relationship between a subscriber and an operator/service provider.

Referring to FIGS. 8A and 8B, in operation 811, the electronic device 101 may identify a user input which triggers profile transfer between electronic devices (e.g., a user input selecting the profile transfer between the electronic devices). For example, the electronic device 101 may output (e.g., display) a user interface (UI) for selecting the profile transfer between the electronic devices (e.g., a profile transfer menu between electronic devices), and identify the user input via the UI. The UI may include information indicating a purpose of selecting to transfer the profile of the external electronic device 800 to the electronic device 101, or information indicating a purpose of selecting to transfer the profile (or subscription or line) from the external electronic device 800 to the electronic device 101 for intuitive recognition by a user.

Based on the user input selecting the profile transfer between the electronic devices (or subscription transfer between the electronic devices, or line transfer between the electronic devices), the electronic device 101 may display a quick response (QR) code in operation 813. Displaying the QR code may be an example of providing the information related to the profile transfer between the electronic devices. Hereinafter, for convenience of description, the information related to the profile transfer between the electronic devices (or subscription transfer between the electronic devices, or line transfer between the electronic devices) will be referred to as “profile transfer information.” In an embodiment, a set security scheme such as raw data and/or hashing may be applied to the QR code. By providing the profile transfer information in the form of the QR code, a separate wireless connection (e.g., a wireless connection based on a short-range wireless communication scheme such as a Bluetooth scheme, a Wi-Fi scheme, a ultra wide band (UWB) scheme, and/or a near field communication (NFC) scheme, or a wireless connection based on a cellular communication scheme such as an LTE scheme, an LTE-A scheme, and/or an NR scheme) may not be required between the electronic devices for the profile transfer between the electronic devices.

In an embodiment, the profile transfer information may be information related to the profile transfer from the existing electronic device (or an existing device) to the new electronic device (or a new device). In an embodiment, the profile may be stored in an eSIM (e.g., a subscriber identity module 196 in FIG. 1A, an eSIM 201 in FIG. 1B, 2, or 3, or an eUICC 401 in FIG. 4) of the existing electronic device, or may be stored in a physical SIM of the existing electronic device, or may be downloaded from an SM-DP+ server (e.g., an SM-DP+ server 220 in FIG. 2, or an SM-DP+ server 530 in FIG. 5, 8A, or 8B). For example, transferring the subscription of the existing electronic device to the new electronic device may mean transferring a profile corresponding to a profile stored in the existing electronic device to the new electronic device. In FIGS. 8A and 8B, because it is assumed that the electronic device 101 is the new electronic device and the external electronic device 800 is the existing electronic device, the profile transfer information may be information related to the profile transfer from the external electronic device 800 to the electronic device 101.

In an embodiment, the profile transfer information may include at least one of a prefix, an operation type, device information, authentication information, an address of an entitlement server (e.g., an entitlement server 520 in FIG. 5, 8A, or 8B), or a phone number.

In an embodiment, the prefix may include a set string. For example, the prefix may be implemented as “ODSA”, and there may be no limitation on an implementation form of the prefix.

In an embodiment, the operation type may be information indicating a source electronic device (or an origin electronic device) which provides the profile transfer information. In an embodiment, the operation type may be implemented with a set number (e.g., two) of bits. For example, if a value of the operation type is a first value (e.g., 01), it may indicate that the profile transfer information is provided from the new electronic device, and in this case, a source electronic device providing the profile transfer information may be the new electronic device. For example, if the value of the action type is a second value (e.g., 10), it may indicate that the profile transfer information is provided from the existing electronic device, and in this case, a source electronic device which provides the profile transfer information may be the existing electronic device.

For example, the values of the operation type may be implemented as shown in Table 1 below.

TABLE 1

| | |
|---|---|
| Operation | 1: Profile Transfer Information from New device |
| Type | 2: Profile Transfer Information from Old device |

As shown in Table 1, if the value of the operation type is the first value (e.g., 1), it may indicate that the profile transfer information is provided from the new electronic device (for example, in Table 1, it is expressed as “Profile Transfer Information from New device”), if the value of the operation type is the second value (e.g., 2), it may indicate that the profile transfer information is provided from the existing electronic device (in Table 1, it is expressed as “Profile Transfer Information from Old device”).

In an embodiment, the authentication information may be authentication information of the existing electronic device, and the authentication information may be obtained via an authentication process between the existing electronic device and an entitlement server related to the existing electronic device. In an embodiment, the authentication information may be authentication information used for connecting to the entitlement server. In an embodiment, the authentication process may be based on an authentication scheme. The authentication scheme may include at least one of an EAP-AKA scheme, an OPEN ID scheme, or an SMS-OTP scheme. The EAP-AKA scheme may be an authentication scheme using a physical SIM (e.g., a USIM) or an eSIM profile, and may follow RFC 4187, but may not be limited thereto. The OPEN ID scheme may be an authentication scheme based on an ID and a password. For example, in the OPEN ID scheme, an authentication operation may be performed using an ID/password on a web page of a communication provider. The ID used in the OPEN ID scheme may be implemented in various forms such as a resident registration number or a social security number, the password may be implemented in various forms such as an SMS-OTP value, and there is no limitation on a form of the ID and the password used in the OPEN ID scheme. The SMS-OTP scheme may be an OTP scheme using an SMS. If the authentication process between the existing electronic device and the entitlement server 520 is an EAP-AKA authentication process, authentication information obtained via the EAP-AKA authentication process between the existing electronic device and the entitlement server 520 may be a token, but there may be no limitation on a form of implementing the authentication information.

In an embodiment, the device information may be device information of a source electronic device which provides the profile transfer information. The device information may include at least one of an international mobile equipment identity (IMEI), an eUICC ID (EID), a model name, or a serial number of the source electronic device.

In an embodiment, the address of the entitlement server may be an address of an entitlement server related to the existing electronic device. In an embodiment, the address of the entitlement server may be an address of the entitlement server to which profile transfer is requested. For example, the profile transfer may be requested to the entitlement server.

In an embodiment, the phone number may be a phone number of the existing electronic device and may be a phone number to which profile transfer is requested.

In an embodiment, the prefix, the operation type, the device information, the phone number, the authentication information, and/or the address of the entitlement server included in the profile transfer information may be arranged based on a set order and may be separated using a delimiter (e.g., $). For example, the profile transfer information may be arranged such as prefix$operation type$device information$phone number$authentication information$address of entitlement server, and there may be no limitation on the arrangement order and the delimiter for the prefix, the operation type, the device information, the phone number, the authentication information, and/or the address of the entitlement server included in the profile transfer information. For example, the delimiter may be implemented in various formats such as “@”, “#”, and/or “%” as well as “$”.

For example, the profile transfer information may be defined in a form shown in Table 2 below.

TABLE 2
prefix$operation type$device information$phone number$authentication
information$address of entitlement server

For example, if the device information includes an IMEI, an EID, a model name, and a serial number, and the authentication information is a token, the profile transfer information may be defined in a form shown in Table 3 below.

TABLE 3

prefix$operation type$IMEI$EID$model name$serial number$phone
number$token$address of entitlement server

In FIGS. 8A and 8B, it has been assumed that the electronic device 101 is the new electronic device and the external electronic device 800 is the existing electronic device, so the profile transfer information may be information related to profile transfer from the external electronic device 800 to the electronic device 101, and the profile transfer information corresponding to the QR code displayed by the electronic device 101 in operation 813 may include a prefix, an operation type, and/or device information. The device information included in the profile transfer information in operation 813 may be the device information of the electronic device 101, and may include the IMEI, the EID, and/or the model name of the electronic device 101. For example, the QR code corresponding to the profile transfer information displayed in operation 813 may be expressed as Table 4 below.

TABLE 4
ODSA$1$354707530000000$89043051202200006222001111111111$SM-S911B
$89821111112222222333F

The electronic device 101 is the source electronic device which provides the profile transfer information, so a value of the operation type in Table 4 is set to “1”. In Table 4, ODSA may be the prefix, 354707530000000 may be the IMEI of the electronic device 101, 89043051202200006222001111111111 may be the EID of the electronic device 101, SM-S911B may be the model name of the electronic device 101, and 8982111111222 2222333F may be an iccid of a profile to be transferred. In an embodiment, the iccid may be a unique serial number of a SIM or an eSIM profile.

In this way, if the electronic device 101, which is the new electronic device, displays the QR code corresponding to the profile transfer information, the external electronic device 800, which is the existing electronic device, may cause the external electronic device 800 to start the profile transferring process between the electronic device 101 and the external electronic device 800 by scanning the QR code outputted on the electronic device 101. In this way, the profile transfer information is provided in the form of the QR code, so even if a separate wireless connection does not exist between the electronic device 101 and the external electronic device 800, the profile transfer between the electronic device 101 and the external electronic device 800 may be possible.

In operation 815, the external electronic device 800 may obtain the profile transfer information. For example, if the electronic device 101 outputs the profile transfer information in the form of the QR code, the external electronic device 800 may obtain the profile transfer information by scanning the QR code outputted from the electronic device 101.

The external electronic device 800, which obtains the profile transfer information, may identify the value of the operation type included in the profile transfer information. The value of the operation type included in the profile transfer information is set to “1”, so the external electronic device 800 may identify that the profile transfer information is provided from the electronic device 101, which is the new electronic device. The external electronic device 800, which identifies that the profile transfer information is provided from the electronic device 101, may display at least one phone number of the external electronic device 800, which is the existing electronic device, in a form of a list to perform the profile transferring process in operation 817. In an embodiment, a phone number of the external electronic device 800 may include a phone number corresponding to a pSIM and/or a phone number corresponding to an eSIM.

The external electronic device 800 may have a plurality of phone numbers. In an embodiment, the external electronic device 800 may include only phone numbers for which profile transfer may be possible in the list, or may mark phone numbers for which profile transfer may be impossible as unselectable to include them in the list. In an embodiment, the external electronic device 800 may identify whether phone numbers owned by the external electronic device 800 are phone numbers for which profile transfer is possible based on profile transfer-related data per service provider. In an embodiment, the external electronic device 800 may identify whether phone numbers owned by the external electronic device 800 are phone numbers for which profile transfer is possible through a communication with a server (e.g., an entitlement server 530) of the service provider.

The external electronic device 800, which displays the list including the at least one phone number, may identify a user input (e.g., a user input for selecting a phone number which is a target for the profile transfer) related to the phone number which is the target for the profile transfer in operation 819. For example, the external electronic device 800 may output (for example, display) the list via a UI, and identify the user input for selecting the phone number which is the target for the profile transfer via the UI.

The external electronic device 800, which identifies the user input for selecting the phone number which is the target for the profile transfer, may transmit, to the entitlement server 520, a first message requesting profile transfer (or subscription transfer) in operation 821. Although not separately shown in FIGS. 8A and 8B, before the external electronic device 800 transmits the first message to the entitlement server 520, an authentication process (e.g., an EAP-AKA authentication process) may be performed between the external electronic device 800 and the entitlement server 520. In an embodiment, the external electronic device 800 may perform the EAP-AKA authentication process based on the selected phone number. If a result of the EAP-AKA authentication process indicates success, the external electronic device 800 may obtain authentication information (e.g., a token). In FIGS. 8A and 8B, it will be assumed that the result of the EAP-AKA authentication process indicates the success, and if the result of the EAP-AKA authentication process indicates failure, the external electronic device 800 may not perform any further operations.

The entitlement server 520, which receives the first message requesting the profile transfer from the external electronic device 800, may perform a profile transferring process in operation 823. In an embodiment, the profile transferring process may be implemented similarly to or substantially the same as specified in “8. Primary ODSA Procedure Call Flows” in a standard document TS. 43 (e.g., TS. 43 Version 9, so a detailed description thereof will be omitted herein.

In an embodiment, the first message may include on-device service activation (ODSA) operation information of “ManageSubscription” as shown in Table A below. “ManageSubscrition” may be ODSA operation information used for requesting a subscription-related operation. According to an embodiment, the first message may include device information (e.g., an IMEI or an BID) and/or authentication-related information of a device (e.g., the external electronic device 800) transmitting the first message. According to an embodiment, the first message may include operation type information in Table B below as parameter information.

TABLE A

| ODSA operation | Description |
|---|---|
| CheckEligibility | To verify if end-user is allowed to invoke |
| | the ODSA application |
| ManageSubscription | To request for subscription-related action |
| | on a primary or companion device. |
| ManageService | To activate/deactivate the service on the |
| | primary or companion device. |
| AcquireConfiguration | To provide service-related data about a |
| | primary or companion device |
| AcquirePlan | To request available plans to be offered |
| | by the MNO to an specific user or MDM |

TABLE B

| Parameter | Type | Values | Description |
|---|---|---|---|
| Operation | Integer | 0-SUBSCRIBE | to activate a subscription |
| type | | | for the eSIM device. |
| | | 1-UNSUBSCRIBE | to cancel a subscription |
| | | | for the eSIM device. |
| | | 2-CHANGE | to manage an existing |
| | | SUBSCRIPTION | subscription on |
| | | | the eSIM device. |
| | | 3-TRANSFER | to transfer a subscription |
| | | SUBSCRIPTION | from an existing device |
| | | | (with physical SIM or |
| | | | eSIM) to the eSIM device |
| | | 4-UPDATE | to inform the network of |
| | | SUBSCRIPTION | a subscription update on |
| | | | the eSIM device |

Referring to Table B, the first message including “ManageSubscription” in Table A as the ODSA operation information may include an operation type of at least one of “SUBSCRIBE”, “UNSUBSCRIBE”, “CHANGE SUBSCRIPTION”, “TRANSFER SUBSCRIPTION”, or “UPDATE SUBSCRIPTION”. The first message transmitted to the entitlement server 520 may include an operation type with a value of “3-TRANSFER SUBSCRIPTION” in Table B. “TRANSFER SUBSCRIPTION” may be an operation type for transferring the profile of the existing electronic device (e.g., the electronic device 101) having an eSIM to another electronic device (e.g., the new electronic device) (e.g., the external electronic device 800) having an eSIM.

The entitlement server 520, which performs the profile transferring process, may transmit a second message requesting a new profile according to the profile transfer to the SM-DP+ server 530 in operation 825. In an embodiment, the second message requesting the new profile may include an identifier of a profile. For example, the identifier of the profile may include a phone number (e.g., the phone number selected at the external electronic device 800), but there may be no limitation on the identifier of the profile.

The SM-DP+ server 530, which receives the second message from the entitlement server 520, may generate the new profile mapped to the corresponding phone number based on the request for the new profile in operation 827. After generating the new profile mapped to the corresponding phone number, the SM-DP+ server 530 may transmit a third message including download information used for downloading the generated new profile to the entitlement server 520 in operation 829. In an embodiment, the download information may include an address of the SM-DP+ server 530 from which the new profile may be downloaded.

In an embodiment, the download information may correspond to a web page. In an embodiment, if the web page is displayed, information may be displayed to the user before the second message is transmitted, or a web page for confirming a final transmission may be displayed to the user. In this way, if the download information corresponding to the web page is provided, the web page may be displayed before the second message is transmitted. The entitlement server 520, which receives the third message including the download information used for downloading the new profile from the SM-DP+ server 530, may transmit a fourth message including download information used for downloading the new profile to the external electronic device 800 in operation 831. The download information used for downloading the new profile included in the fourth message transmitted in operation 831 may be the same as the download information used for downloading the new profile included in the third message transmitted in operation 829, or may be based on at least part of the download information used for downloading the new profile included in the third message.

In an embodiment, the fourth message may include subscription result (“SubscriptionResult”) information in Table C below as parameter information.

TABLE C

| “Manage Subscription” | | | |
|---|---|---|---|
| Configuration | | | |
| parameters | Type | Values | Description |
| SubscriptionResult | Integer | 1 - CONTINUE | Indicates that end-user must go through the |
| (Mandatory) | | TO WEBSHEET | subscription web view procedure, using |
| | | | information included below. |
| | | 2 - | Indicates that a eSIM profile must be downloaded |
| | | DOWNLOAD | by the device, with further information included |
| | | PROFILE | in response |
| | | 3 - DONE | Indicates that subscription flow has ended and the |
| | | | end-user has already downloaded the eSIM profile |
| | | | so there is no need to perform any other action. |
| | | 4 - DELAYED | Indicates that an eSIM profile is not ready to be |
| | | DOWNLOAD | downloaded when a user requests to transfer |
| | | | subscription or to add the new subscription |
| | | | through native UX on the eSIM device. |
| | | 5 - DISMISS | Indicates that subscription flow has ended |
| | | | without completing the ODSA procedure. An |
| | | | eSIM profile is not available. |
| | | 6 - DELETE | Indicates that the profile in use needs to be |
| | | PROFILE IN | deleted to complete the subscription transfer. |
| | | USE | |
| SubscriptionServiceURL | String | URL to a | Present only if SubscriptionResult is “1”. URL |
| (Conditional) | | Service Provider | refers to web views responsible for a certain |
| | | site or portal | action on the eSIM device subscription. |
| | | | The Service Provider can provide different URL |
| | | | based on the operation_type input parameter |
| | | | (subscribe, unsubscribe, change subscription). |

For example, the fourth message may include “CONTINUE TO WEBSHEET” and may further include address information (e.g., SubscriptionServiceURL) accessible to a web server and/or user-related data (e.g., SubscriberData). According to an embodiment, the fourth message may include download information which may be used for downloading directly transferred profile instead of the address information accessible to the web server.

The external electronic device 800, which receives the fourth message including the download information used for downloading the new profile from the entitlement server 520, may output (for example, may display) the download information used for downloading the new profile included in the fourth message in a form of a QR code in operation 833. In an embodiment, a format of the download information used for downloading the new profile may be implemented similarly to or substantially the same as specified in “4.1 Activation Code” in a standard document SGP. 22 (e.g., SGP. 22 Version 3.0), and the standard document SGP. 22 (e.g., SGP. 22 Version 3.0) specifies Activation Code as shown in Table 5 below. Therefore, a detailed description of the format of the download information used for downloading the new profile will be omitted.

TABLE 5

| Name | Description | MOC |
|---|---|---|
| AC_Format | Format of the Activation Code. SHALL be set to “1” for this format of | M |
| | the Activation Code and any subsequent backward compatible format | |
| | NOTE: The value “2” designates an Advanced Activation Code, as | |
| | described in section 4.1a | |
| Delimiter | SHALL be set to “$” | M |
| SM-DP + | FQDN (Fully Qualified Domain Name) of the SM-DP + (e.g., | M |
| Address | SMDP.EXAMPLE.COM) restricted to the Alphanumeric mode | |
| | character set defined in table 5 of ISO/IEC 18004 [15] excluding “$” | |
| Delimiter | SHALL be set to “$” | M |
| AC_Token | MatchingID as described in section (0) | M |
| Delimiter | SHALL be present and set to “$” if any of the following optional | C |
| | parameters is present | |
| SM-DP + OID | SM-DP + OID in the CERT.DPauth.SIG | O |
| Delimiter | SHALL be present and set to “$” if any of the following optional | C |
| | parameters is present | |
| Confirmation | SHALL be present and set to “1” if Confirmation Code is required; | O |
| Code Required | otherwise it SHALL be absent | |
| Flag | | |
| Delimiter | SHALL be present and set to “$” if any of the following optional | C |
| | parameters is present | |
| CI Public Key | #SupportedFromV3.0.0# | O |
| indicator | If present, it specifies an indicator of an eSIM CA RootCA public | |
| | key as specified below. | |
| Delimiter | SHALL be present and set to “$” if any of the following optional | C |
| | parameters is present | |
| Delete | #SupportedForDcV3.0.0# | O |
| Notification for | If present in an Activation Code, it specifies the Delete Notification | |
| Device Change | for Device Change. See section 4.1.3. | |

In operation 835, the electronic device 101 may obtain the download information used for downloading the new profile. For example, if the external electronic device 800 outputs the download information used for downloading the new profile in the form of the QR code, the electronic device 101 may scan the QR code outputted from the external electronic device 800 to obtain the download information used for downloading the new profile. In this way, the external electronic device 800 outputs the download information used for downloading the new profile in the form of the QR code, thereby a separate wireless connection (e.g., a wireless connection based on a short-range wireless communication scheme such as a Bluetooth scheme, a Wi-Fi scheme, a UWB scheme, and/or an NFC scheme, or a wireless connection based on a cellular communication scheme such as an LTE scheme, an LTE-A method, and/or an NR scheme) may not be necessary.

The electronic device 101, which obtains the download information, may download the generated new profile from the SM-DP+ server 530 based on the download information in operation 837.

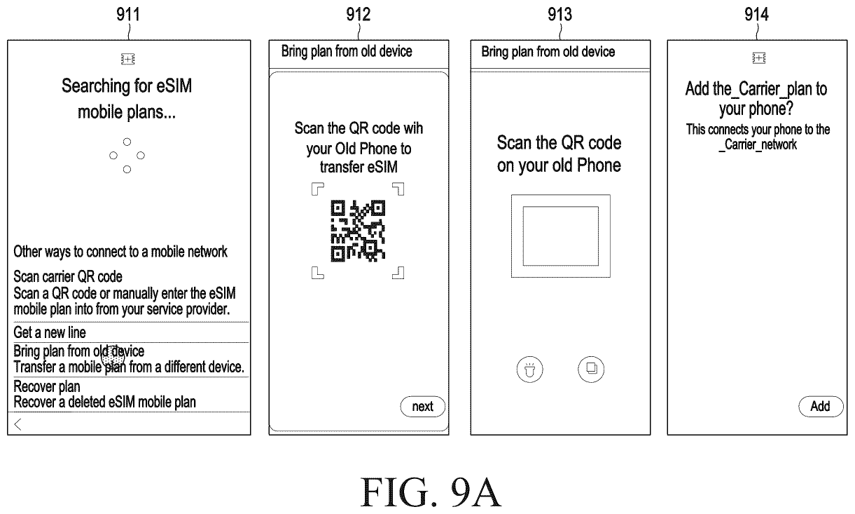

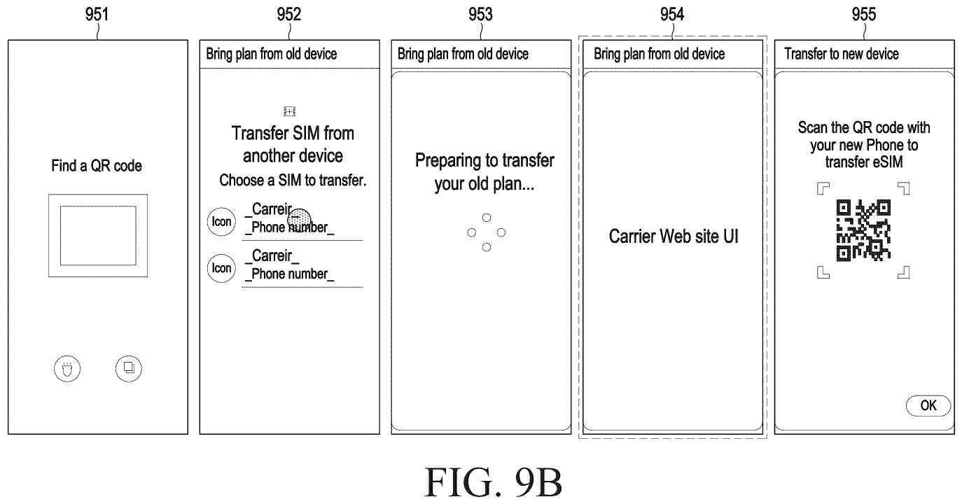

FIG. 9A is a diagram for describing screens displayed on an electronic device according to an embodiment of the disclosure.

FIG. 9B is a diagram for describing screens displayed on an electronic device according to an embodiment of the disclosure.

Screens 911 to 914 illustrated in FIG. 9A may be screens provided by a new electronic device (an electronic device (e.g., an electronic device 101 in FIG. 1A, 1B, 2, 3, 5, 8A, or 8B)) according to a profile transferring process between electronic devices described in FIGS. 8A and 8B. Screens 951 to 955 illustrated in FIG. 9B may be screens provided by an existing electronic device (e.g., an external electronic device (e.g., an electronic device 102 or an electronic device 104 in FIG. 1A, or an external electronic device 800 in FIG. 8A or 8B)) according to a profile transferring process between electronic devices described in FIGS. 8A and 8B. The profile transferring process described in FIGS. 8A and 8B may be a profile transferring process in a case that an electronic device, which is the new electronic device, triggers the profile transferring process, and an external electronic device, which is the existing electronic device, obtains profile transfer information from the electronic device, and requests profile transfer from an entitlement server (e.g., an entitlement server 520 in FIG. 5, 8A, or 8B) based on the obtained profile transfer information.

Referring to FIGS. 9A and 9B, the electronic device, which is the new electronic device, may output (for example, may display) a screen 911 for selecting to transfer, to the electronic device, a profile of the external electronic device, which is the existing electronic device. The screen 911 may be associated with operation 811 in FIG. 8A.

When identifying a user input for selecting the profile transfer between the electronic devices via the screen 911, the electronic device may output a screen 912 which provides a QR code corresponding to the profile transfer information. The screen 912 may be associated with operation 813 in FIG. 8A.

The external electronic device may obtain the profile transfer information by scanning the QR code outputted on the screen 912, which may correspond to a screen 951. The screen 951 may be associated with operation 815 in FIG. 8A. The external electronic device, which obtains the profile transfer information via the screen 951, may output a list including at least one phone number of the external electronic device (e.g., at least one phone number for which profile transfer is possible), and this may correspond to a screen 952. The screen 952 may be associated with operation 817 in FIG. 8A.

When identifying a user input for selecting a phone number which is a target among the at least one phone number of the external electronic device via the screen 952, the external electronic device may transmit a first message requesting the profile transfer to an entitlement server 520 (e.g., an entitlement server 520 in FIG. 5, 8A, or 8B), thereby the profile transferring process may be performed, and this may correspond to a screen 953. The screen 953 may be associated with operation 821 in FIG. 8A.

As the profile transferring process is performed in this way, the external electronic device may receive a fourth message including the download information used for downloading the new profile from the entitlement server, and output a web page or a QR code corresponding to the download information, and this may correspond to a screen 954 or a screen 955. The screen 954 or the screen 955 may be associated with operation 833 in FIG. 8B.

The electronic device may obtain the download information via the screen 954 or the screen 955, and this may correspond to a screen 913. The screen 913 may be associated with operation 835 in FIG. 8B.

The electronic device, which obtains the download information, may download the new profile from an SM-DP+ server (e.g., an SM-DP+ server 220 in FIG. 2, or an SM-DP+ server 530 in FIG. 5, 8A, or FIG. 8B) based on the download information, and this may correspond to a screen 914. The screen 914 may be associated with operation 837 in FIG. 8B.

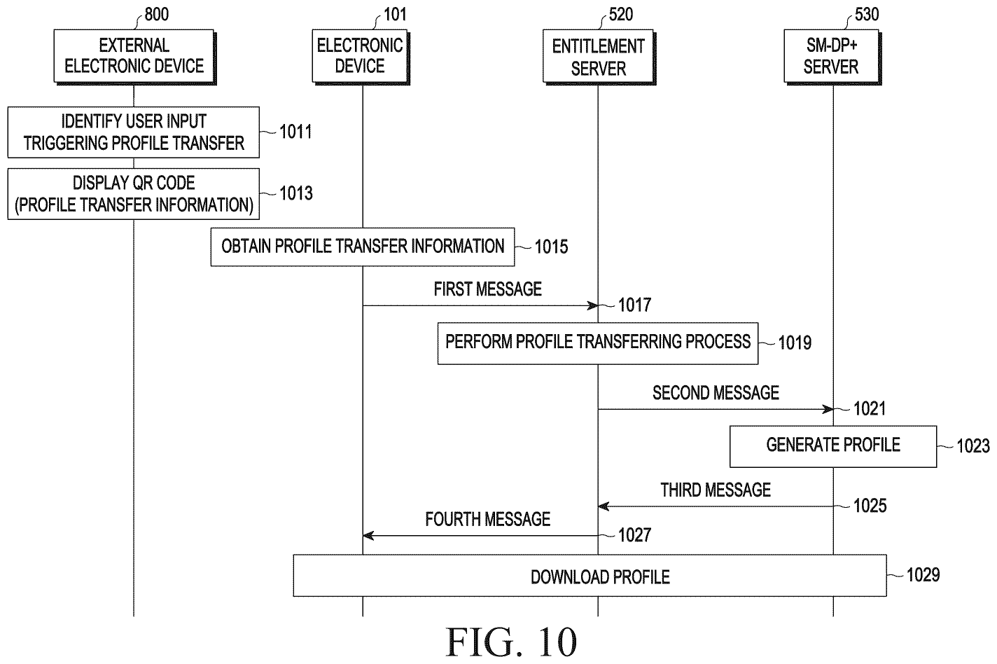

FIG. 10 is a signal flowchart illustrating a profile transferring process between electronic devices according to an embodiment of the disclosure.

A profile transferring process between electronic devices illustrated in FIG. 10 may be a profile transferring process between electronic devices in a case that an external electronic device 800 (e.g., an electronic device 102 or an electronic device 104 in FIG. 1A, or an external electronic device 800 in FIG. 8A or 8B), which is an existing electronic device, triggers profile transfer between the external electronic device 800 and an electronic device 101 (e.g., an electronic device 101 in FIG. 1A, 1B, 2, 3, 5, 8A, or 8B) which is a new electronic device.

Referring to FIG. 10, in operation 1011, the external electronic device 800 may identify a user input which triggers profile transfer between electronic devices (e.g., a user input selecting the profile transfer between the electronic devices). For example, the external electronic device 800 may output (e.g., display) a UI for selecting the profile transfer between the electronic devices (e.g., a profile transfer menu between electronic devices), and identify the user input via the UI. The UI may include information indicating a purpose of selecting to transfer the profile of the external electronic device 800 to the electronic device 101, or information indicating a purpose of selecting to transfer the profile (or subscription or line) from the external electronic device 800 to the electronic device 101 for intuitive recognition by a user. In an embodiment, the UI for selecting the profile transfer between the electronic devices may be provided in a form of a sub-menu mapped to at least one phone number of the external electronic device 800.

Based on the user input selecting the profile transfer between the electronic devices (or subscription transfer between the electronic devices, or line transfer between the electronic devices), the external electronic device 800 may display a QR code in operation 1013. Displaying the QR code may be an example of providing profile transfer information which is information related to the profile transfer between the electronic devices (or subscription transfer between the electronic devices, or line transfer between the electronic devices). In an embodiment, a set security scheme such as raw data and/or hashing may be applied to the QR code. By providing the profile transfer information in the form of the QR code, a separate wireless connection (e.g., a wireless connection based on a short-range wireless communication scheme such as a Bluetooth scheme, a Wi-Fi scheme, a UWB scheme, and/or an NFC scheme, or a wireless connection based on a cellular communication scheme such as an LTE scheme, an LTE-A scheme, and/or an NR scheme) may not be required between the electronic devices for the profile transfer between the electronic devices.

In an embodiment, the profile transfer information may be information related to the profile transfer from the existing electronic device (or an existing device) to the new electronic device (or a new device). In an embodiment, the profile may be stored in an eSIM (e.g., a subscriber identity module 196 in FIG. 1A, an eSIM 201 in FIG. 1B, 2, or 3, or an eUICC 401 in FIG. 4) of the existing electronic device, or may be stored in a physical SIM of the existing electronic device, or may be downloaded from an SM-DP+ server (e.g., an SM-DP+ server 220 in FIG. 2, or an SM-DP+ server 530 in FIG. 5, 8A, 8B, or 10). For example, transferring the subscription of the existing electronic device to the new electronic device may mean transferring a profile (or a new profile) corresponding to a profile stored in the existing electronic device to the new electronic device. In FIG. 10, because it is assumed that the electronic device 101 is the new electronic device and the external electronic device 800 is the existing electronic device, the profile transfer information may be information related to the profile transfer from the external electronic device 800 to the electronic device 101.

In an embodiment, the profile transfer information may include at least one of a prefix, an operation type, device information, authentication information, an address of an entitlement server (e.g., an entitlement server 520 in FIG. 5, 8A, 8B, or 10), or a phone number. The prefix, the operation type, the device information, the authentication information, the address of the entitlement server, and/or the phone number which may be included in the profile transfer information may be implemented similarly to or substantially the same as described in FIGS. 8A and 8B, so a detailed description thereof will be omitted herein.

In FIG. 10, it has been assumed that the electronic device 101 is the new electronic device and the external electronic device 800 is the existing electronic device, so the profile transfer information may be information related to profile transfer from the external electronic device 800 to the electronic device 101, and the profile transfer information corresponding to the QR code displayed by the external electronic device 800 in operation 1013 may include a prefix, an operation type, device information, the phone number, the authentication information, and/or the address of the entitlement server.

The device information included in the profile transfer information in operation 1013 may be the device information of the external electronic device 800, and may include the IMEI, the EID, and/or the model name of the external electronic device 800.

In operation 1013, the external electronic device 800 accesses a provider server (e.g., an authentication server) for profile transfer between the external electronic device 800 and the electronic device 101 to obtain the authentication information included in the profile transfer information from the provider server. In an embodiment, the authentication information may include a token. In an embodiment, a process in which the external electronic device 800 accesses the authentication server to obtain the authentication information from the authentication server may be implemented similarly to or substantially the same as specified in “8.9 Subscription Transfer with TemporaryToken” in a standard document TS. 43 (e.g., TS. 43 Version 9), so a detailed description thereof will be omitted herein.

For example, the QR code corresponding to the profile transfer information displayed in operation 1013 may be expressed as Table 6 below.

TABLE 6
ODSA$2$354707530000001$89043051202200006222001111111110$SM-
S911B$01012345678$ADKFJ3934587AEKASDFHJA:SDLFJ39&4AKD*DKFG1$https://www.odsa.es.samsumg.co
m$89821111112222222333F

The external electronic device 800 is the source electronic device which provides the profile transfer information, so a value of the operation type in Table 6 is set to “2”. In Table 6, ODSA may be the prefix, 354707530000001 may be the IMEI of the external electronic device 800, 89043051202200006222001111111110 may be the EID of the external electronic device 800, SM-S911B may be the model name of the external electronic device 800, 01012345678 is the phone number of the external electronic device 800, ADKFJ3934587AEKASDFHJA;SDLFJ39&4AKD*DKFG1 is the authentication information of the external electronic device 800, and https://www.odsa.es.samsung.com is the address of the entitlement server associated with the external electronic device 800 (to which profile transfer is to be requested), and 8982111111222 2222333F may be an iccid of a profile to be transferred. In an embodiment, the iccid may be a unique serial number of a SIM or an eSIM profile.

In this way, if the external electronic device 800, which is the existing electronic device, displays the QR code corresponding to the profile transfer information, the electronic device 101, which is the new electronic device, may cause the electronic device 101 to start the profile transferring process between the electronic device 101 and the external electronic device 800 by scanning the QR code outputted on the external electronic device 800. In this way, the profile transfer information is provided in the form of the QR code, so even if a separate wireless connection does not exist between the electronic device 101 and the external electronic device 800, the profile transfer between the electronic device 101 and the external electronic device 800 may be possible.

In operation 1015, the electronic device 101 may obtain the profile transfer information. For example, if the external electronic device 800 outputs the profile transfer information in the form of the QR code, the electronic device 101 may obtain the profile transfer information by scanning the QR code outputted from the external electronic device 800.

The external electronic device 800, which obtains the profile transfer information, may identify the value of the operation type included in the profile transfer information. The value of the operation type included in the profile transfer information is set to “2”, so the electronic device 101 may identify that the profile transfer information is provided from the external electronic device 800 which is the existing electronic device. The electronic device 101, which identifies that the profile transfer information is provided from the external electronic device 800, may transmit a first message requesting profile transfer (or subscription transfer) to the entitlement server 520 based on the authentication information included in the profile transfer information in operation 1017. The first message transmitted in operation 1017 may include device information of the electronic device 101, which is a new electronic device. The device information of the electronic device 101 may include an IMEI, an EID, and/or a model name of the electronic device 101. The first message transmitted in operation 1017 may include authentication information (e.g., a token) of the electronic device 101.

The entitlement server 520, which receives the first message requesting the profile transfer from the electronic device 101, may perform a profile transferring process in operation 1019. In an embodiment, the profile transferring process may be implemented similarly to or substantially the same as specified in “8. Primary ODSA Procedure Call Flows” in a standard document TS. 43 (e.g., TS. 43 Version 9, so a detailed description thereof will be omitted herein. However, the first message includes the authentication information (e.g., the token) of the electronic device 101, so the entitlement server 520 may not separately perform an authenticating operation with the electronic device 101 in the profile transfer process. The first message may be implemented similarly to or substantially the same as that described in FIGS. 8A and 8B, so a detailed description thereof will be omitted herein.

The entitlement server 520, which performs the profile transferring process, may transmit a second message requesting a new profile according to the profile transfer to the SM-DP+ server 530 in operation 1021. In an embodiment, the second message requesting the new profile may include an identifier of a profile. For example, the identifier of the profile may include a phone number (e.g., the phone number of the external electronic device 800), but there may be no limitation on the identifier of the profile.

The SM-DP+ server 530, which receives the second message from the entitlement server 520, may generate the new profile mapped to the corresponding phone number based on the request for the new profile in operation 1023. After generating the new profile mapped to the corresponding phone number, the SM-DP+ server 530 may transmit a third message including download information used for downloading the generated new profile to the entitlement server 520 in operation 1025. In an embodiment, the download information may include an address of the SM-DP+ server 530 from which the new profile may be downloaded.

The entitlement server 520, which receives the third message including the download information used for downloading the new profile from the SM-DP+ server 530, may transmit a fourth message including download information used for downloading the new profile to the electronic device 101 in operation 1027. The download information used for downloading the new profile included in the fourth message transmitted in operation 1027 may be the same as the download information used for downloading the new profile included in the third message transmitted in operation 1025, or may be based on at least part of the download information used for downloading the new profile included in the third message. The fourth message may be implemented similarly to or substantially the same as that described in FIGS. 8A and 8B, so a detailed description thereof will be omitted herein.

In an embodiment, the download information may correspond to a web page. In an embodiment, if the web page is displayed, information may be displayed to the user before the second message is transmitted, or a web page for confirming a final transmission may be displayed to the user. In this way, if the download information corresponding to the web page is provided, the web page may be displayed before the second message is transmitted.

The electronic device 101, which receives a fourth message including the download information used for downloading the new profile from the entitlement server 520, may obtain the download information used for downloading the new profile included in the fourth message, and download a generated new profile from the SM-DP+ server 530 based on the download information in operation 1029.

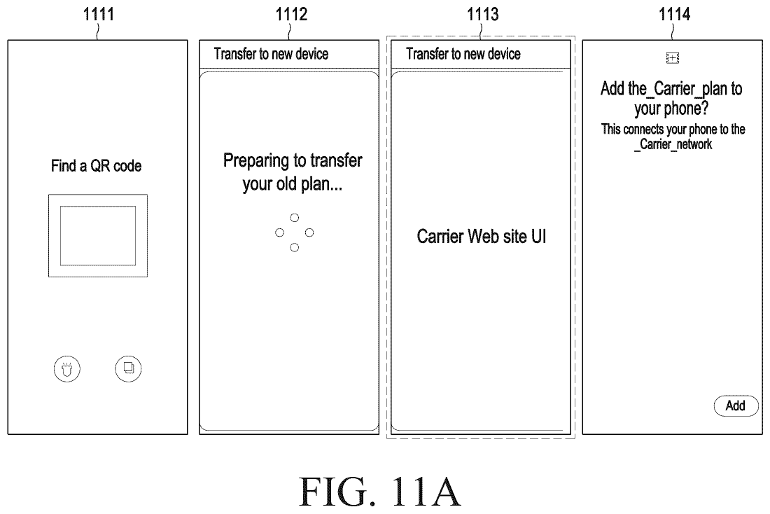

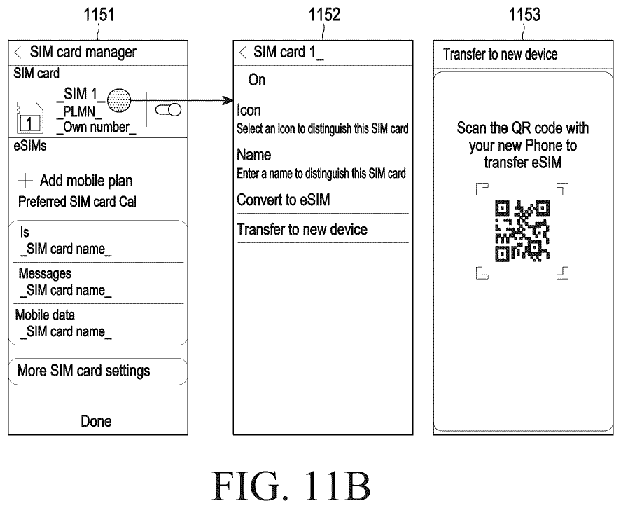

FIG. 11A is a diagram for describing screens displayed on an electronic device according to an embodiment of the disclosure.

FIG. 11B is a diagram for describing screens displayed on an electronic device according to an embodiment of the disclosure.

Screens 1111 to 1114 illustrated in FIG. 11A may be screens provided by a new electronic device (an electronic device (e.g., an electronic device 101 in FIG. 1A, 1B, 2, 3, 5, 8A, 8B, or 10)) according to a profile transferring process between electronic devices described in FIG. 10. Screens 1151 to 1153 illustrated in FIG. 11B may be screens provided by an existing electronic device (e.g., an external electronic device (e.g., an electronic device 102 or an electronic device 104 in FIG. 1A, or an external electronic device 800 in FIG. 8A, 8B, or 10) according to a profile transferring process between electronic devices described in FIG. 10. The profile transferring process described in FIG. 10 may be a profile transferring process in a case that an external electronic device, which is the existing electronic device, triggers the profile transferring process, and an electronic device, which is the new electronic device, obtains profile transfer information from the external electronic device, and requests profile transfer from an entitlement server (e.g., an entitlement server 520 in FIG. 5, 8A, 8B, or 10) based on the obtained profile transfer information.

Referring to FIGS. 11A and 11B, the external electronic device, which is the existing electronic device, may output (for example, may display) screens 1151 and 1152 for selecting to transfer, to the electronic device which is the new electronic device, a profile of the external electronic device. The screens 1151 and 1152 may be associated with operation 1011 in FIG. 10.

When identifying a user input for selecting the profile transfer between the electronic devices via the screen 1151 and 1152, the external electronic device may output a screen 1153 which provides a QR code corresponding to the profile transfer information. The screen 1153 may be associated with operation 1013 in FIG. 10.

The electronic device may obtain the profile transfer information by scanning the QR code outputted on the screen 1153, which may correspond to a screen 1111. The screen 1111 may be associated with operation 1015 in FIG. 10. The electronic device, which obtains the profile transfer information via the screen 1111, may transmit a first message requesting the profile transfer to an entitlement server 520 (e.g., an entitlement server 520 in FIG. 5, 8A, or 8B), thereby the profile transferring process may be performed, and this may correspond to a screen 1112. The screen 1112 may be associated with operation 1017 in FIG. 10. The first message may be implemented similarly to or substantially the same as that described in FIGS. 8A and 8B, so a detailed description thereof will be omitted herein.

As the profile transferring process is performed in this way, the electronic device may receive a fourth message including the download information used for downloading the new profile from the entitlement server, and output a web page corresponding to the download information, and this may correspond to a screen 1113. The screen 1113 may be associated with operation 1027 in FIG. 10. The fourth message may be implemented similarly to or substantially the same as that described in FIGS. 8A and 8B, so a detailed description thereof will be omitted herein.

As described in operation 1027, if the web page is displayed, information may be displayed to a user before a second message is transmitted, or a web page for confirmation of the final transmission may be displayed to the user. In this way, if the download information corresponding to the web page is provided, the web page may be displayed before the second message is transmitted.

The electronic device, which obtains the download information, may download the new profile from an SM-DP+ server (e.g., an SM-DP+ server 220 in FIG. 2, or an SM-DP+ server 530 in FIG. 5, 8A, or 8B) based on the download information, and this may correspond to a screen 1114. The screen 1114 may be associated with operation 1029 in FIG. 10.

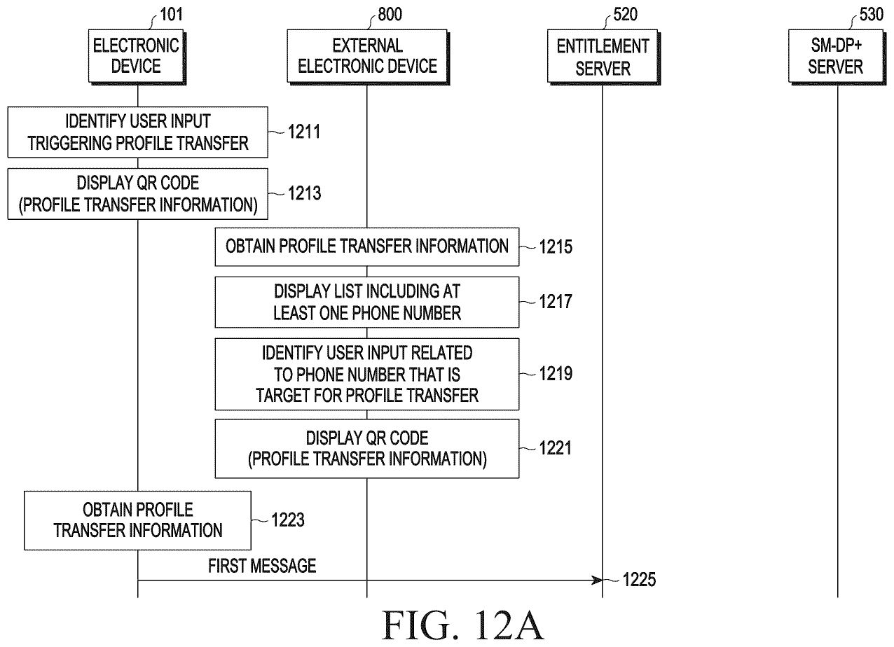

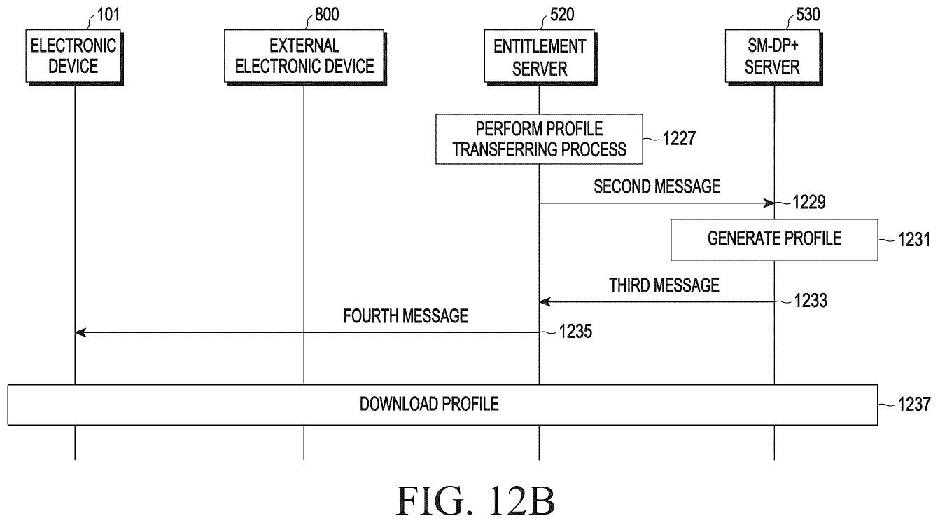

FIG. 12A is a signal flowchart illustrating a profile transferring process between electronic devices according to an embodiment of the disclosure.

FIG. 12B is a signal flowchart illustrating a profile transferring process between electronic devices according to an embodiment of the disclosure.

A profile transferring process between electronic devices illustrated in FIGS. 12A and 12B may be a profile transferring process between electronic devices in a case that an electronic device 101 (e.g., an electronic device 101 in FIG. 1A, 1B, 2, 3, 5, 8A, 8B, or 10), which is a new electronic device, triggers profile transfer between the electronic device 101 and an external electronic device 800 (e.g., an electronic device 102 or an electronic device 104 in FIG. 1A, or an external electronic device 800 in FIG. 8A, 8B, or 10) which is an existing electronic device. However, in a profile transferring process between electronic devices illustrated in FIGS. 8A and 8B, the electronic device 101, which is the new electronic device, may trigger profile transfer, and the external electronic device 800, which is the existing electronic device, may obtain profile transfer information from the electronic device 101, and request the profile transfer from an entitlement server 520 based on the profile transfer information which the external electronic device 800 obtains from the electronic device 101. Alternatively, in a profile transferring process between electronic devices illustrated in FIGS. 12A and 12B, the electronic device 101, which is the new electronic device, may trigger profile transfer, the external electronic device 800, which is the existing electronic device, may obtain profile transfer information from the electronic device 101, the external electronic device 800 may provide profile transfer information of the external electronic device 800 based on the obtained profile transfer information, and the electronic device 101 may request the profile transfer from an entitlement server 520 based on the profile transfer information provided by the external electronic device 800. In an embodiment, the new electronic device may be an electronic device which will download a profile, and the existing electronic device may be an electronic device in which the profile has already been downloaded.

Referring to FIGS. 12A and 12B, in operation 1211, the electronic device 101 may identify a user input which triggers profile transfer between electronic devices (e.g., a user input selecting the profile transfer between the electronic devices). For example, the electronic device 101 may output (e.g., display) a UI for selecting the profile transfer between the electronic devices (e.g., a profile transfer menu between electronic devices), and identify the user input via the UI. The UI may include information indicating a purpose of selecting to transfer the profile of the external electronic device 800 to the electronic device 101, or information indicating a purpose of selecting to transfer the profile (or subscription or line) from the external electronic device 800 to the electronic device 101 for intuitive recognition by a user.

Based on the user input selecting the profile transfer between the electronic devices (or subscription transfer between the electronic devices, or line transfer between the electronic devices), the electronic device 101 may display a QR code in operation 1213. Displaying the QR code may be an example of providing profile transfer information which is information related to the profile transfer between the electronic devices (or subscription transfer between the electronic devices, or line transfer between the electronic devices). In an embodiment, a set security scheme such as raw data and/or hashing may be applied to the QR code. By providing the profile transfer information in the form of the QR code, a separate wireless connection (e.g., a wireless connection based on a short-range wireless communication scheme such as a Bluetooth scheme, a Wi-Fi scheme, a UWB scheme, and/or an NFC scheme, or a wireless connection based on a cellular communication scheme such as an LTE scheme, an LTE-A scheme, and/or an NR scheme) may not be required between the electronic devices for the profile transfer between the electronic devices.

In an embodiment, the profile transfer information may be information related to the profile transfer from the existing electronic device (or an existing device) to the new electronic device (or a new device). In an embodiment, the profile may be stored in an eSIM (e.g., a subscriber identity module 196 in FIG. 1A, an eSIM 201 in FIG. 1B, 2, or 3, or an eUICC 401 in FIG. 4) of the existing electronic device, or may be stored in a physical SIM of the existing electronic device, or may be downloaded from an SM-DP+ server (e.g., an SM-DP+ server 220 in FIG. 2, or an SM-DP+ server 530 in FIG. 5, 8A, 8B, 10, 12A, or 12B). For example, transferring the subscription of the existing electronic device to the new electronic device may mean transferring a profile corresponding to a profile stored in the existing electronic device to the new electronic device. In FIGS. 12A and 12B, because it is assumed that the electronic device 101 is the new electronic device and the external electronic device 800 is the existing electronic device, the profile transfer information may be information related to the profile transfer from the external electronic device 800 to the electronic device 101.

In an embodiment, the profile transfer information may include at least one of a prefix, an operation type, device information, authentication information, an address of an entitlement server (e.g., an entitlement server 520 in FIG. 5, 8A, 8B, 10, 12A, or 12B), or a phone number. The prefix, the operation type, the device information, the authentication information, the address of the entitlement server, and/or the phone number which may be included in the profile transfer information may be implemented similarly to or substantially the same as described in FIGS. 8A and 8B, so a detailed description thereof will be omitted herein.

In FIGS. 12A and 12B, it has been assumed that the electronic device 101 is the new electronic device and the external electronic device 800 is the existing electronic device, so the profile transfer information may be information related to profile transfer from the external electronic device 800 to the electronic device 101, and the profile transfer information corresponding to the QR code displayed by the electronic device 101 in operation 1213 may include a prefix, an operation type, and/or device information.

The device information included in the profile transfer information in operation 1213 may be the device information of the electronic device 101, and may include the IMEI, the EID, and/or the model name of the electronic device 101. For example, the QR code corresponding to the profile transfer information displayed in operation 1213 may be expressed as Table 7 below.

TABLE 7
ODSA$1$354707530000000$89043051202200006222001111111111$SM-S911B
$89821111112222222333F

The electronic device 101 is the source electronic device which provides the profile transfer information, so a value of the operation type in Table 7 is set to “1”. In Table 7, ODSA may be the prefix, 354707530000000 may be the IMEI of the electronic device 101, 89043051202200006222001111111111 may be the EID of the electronic device 101, SM-S911B may be the model name of the electronic device 101, and 8982111111222 2222333F may be an iccid of a profile to be transferred. In an embodiment, the iccid may be a unique serial number of a SIM or an eSIM profile.

In this way, if the electronic device 101, which is the new electronic device, displays the QR code corresponding to the profile transfer information, the external electronic device 800, which is the existing electronic device, may cause the external electronic device 800 to start the profile transferring process between the electronic device 101 and the external electronic device 800 by scanning the QR code outputted on the electronic device 101. In this way, the profile transfer information is provided in the form of the QR code, so even if a separate wireless connection does not exist between the electronic device 101 and the external electronic device 800, the profile transfer between the electronic device 101 and the external electronic device 800 may be possible.

In operation 1215, the external electronic device 800 may obtain the profile transfer information. For example, if the electronic device 101 outputs the profile transfer information in the form of the QR code, the external electronic device 800 may obtain the profile transfer information by scanning the QR code outputted from the electronic device 101.

The external electronic device 800, which obtains the profile transfer information, may identify the value of the operation type included in the profile transfer information. The value of the operation type included in the profile transfer information is set to “1”, so the external electronic device 800 may identify that the profile transfer information is provided from the electronic device 101, which is the new electronic device. The external electronic device 800, which identifies that the profile transfer information is provided from the electronic device 101, may display at least one phone number of the external electronic device 800, which is the existing electronic device, in a form of a list to perform the profile transferring process in operation 1217. In an embodiment, a phone number of the external electronic device 800 may include a phone number corresponding to a pSIM and/or a phone number corresponding to an eSIM. Operation 1217 may be implemented similarly to or substantially the same as that described in operation 817 in FIG. 8A, so a detailed description thereof will be omitted herein.

The external electronic device 800, which displays the list including the at least one phone number, may identify a user input (e.g., a user input for selecting a phone number which is a target for the profile transfer) related to the phone number which is the target for the profile transfer in operation 1219. For example, the external electronic device 800 may output (for example, display) the list via a UI, and identify the user input for selecting the phone number which is the target for the profile transfer via the UI.

The external electronic device 800, which identifies the user input for selecting the phone number which is the target for the profile transfer, may display a QR code in operation 1221. In an embodiment, displaying the QR code may be an example of providing profile transfer information which is information related to the profile transfer between the electronic devices (or subscription transfer between the electronic devices, or line transfer between the electronic devices).

The profile transfer information corresponding to the QR code displayed by the external electronic device 800 in operation 1221 may include a prefix, an operation type, device information, the phone number, the authentication information, and/or the address of the entitlement server.

The device information included in the profile transfer information in operation 1221 may be the device information of the external electronic device 800, and may include the IMEI, the EID, and/or the model name of the external electronic device 800.

In operation 1221, the external electronic device 800 accesses a provider server (e.g., an entitlement server) for profile transfer between the external electronic device 800 and the electronic device 101 to obtain the authentication information included in the profile transfer information from the provider server. In an embodiment, the authentication information may include a token. In an embodiment, the entitlement server may also be implemented as including an authentication server. In an embodiment, a process in which the external electronic device 800 accesses the entitlement server to obtain the authentication information from the entitlement server (or a process in which the external electronic device 800 accesses the entitlement server to obtain the authentication information from an authentication server via the entitlement server) may be implemented similarly to or substantially the same as specified in “8.9 Subscription Transfer with TemporaryToken” in a standard document TS. 43 (e.g., TS. 43 Version 9), so a detailed description thereof will be omitted herein.

For example, the QR code corresponding to the profile transfer information displayed in operation 1221 may be expressed as Table 8 below.

TABLE 8
ODSA$2$354707530000001$89043051202200006222001111111110$SM-
S911B$01012345678$ADKFJ3934587AEKASDFHJA:SDLFJ39&4AKD*DKFG1$https://www.odsa.es.samsumg.co
m$89821111112222222333F

The external electronic device 800 is the source electronic device which provides the profile transfer information, so a value of the operation type in Table 8 is set to “2”. In Table 8, ODSA may be the prefix, 354707530000001 may be the IMEI of the external electronic device 800, 89043051202200006222001111111110 may be the EID of the external electronic device 800, SM-S911B may be the model name of the external electronic device 800, 01012345678 is the phone number of the external electronic device 800, ADKFJ3934587AEKASDFHJA;SDLFJ39&4AKD*DKFG1 is the authentication information of the external electronic device 800, and https://www.odsa.es.samsung.com is the address of the entitlement server associated with the external electronic device 800 (for example, to which profile transfer is to be requested), and 8982111111222 2222333F may be an iccid of a profile to be transferred. In an embodiment, the iccid may be a unique serial number of a SIM or an eSIM profile.

In this way, if the external electronic device 800, which is the existing electronic device, displays the QR code corresponding to the profile transfer information, the electronic device 101, which is the new electronic device, may obtain the profile transfer information by scanning the QR code outputted on the external electronic device 800.

In operation 1223, the electronic device 101 may obtain the profile transfer information. For example, if the external electronic device 800 outputs the profile transfer information in the form of the QR code, the electronic device 101 may obtain the profile transfer information by scanning the QR code outputted from the external electronic device 800.

The electronic device 101, which obtains the profile transfer information, may transmit, to the entitlement server 520, a first message requesting profile transfer (or subscription transfer) in operation 1225. The first message may include authentication information included in profile transfer information obtained from the external electronic device 800. The first message may be implemented similarly to or substantially the same as that described in FIGS. 8A and 8B, so a detailed description thereof will be omitted herein.

Although not separately illustrated in FIGS. 12A and 12B, the profile transfer information corresponding to the QR code displayed in operation 1221 may include only the prefix, the operation type, the device information, the phone number, and/or the address of the entitlement server, and may not include the authentication information. In this case, the electronic device 101 may obtain the authentication information via an authentication process which is based on an OPEN ID scheme or an SMS-OTP scheme, and may include, in the first message, the authentication information obtained via the authentication process which is based on the OPEN ID scheme or the SMS-OTP scheme.

The entitlement server 520, which receives the first message requesting the profile transfer from the external electronic device 800, may perform a profile transferring process in operation 1227. In an embodiment, the profile transferring process may be implemented similarly to or substantially the same as specified in “8. Primary ODSA Procedure Call Flows” in a standard document TS. 43 (e.g., TS. 43 Version 9, so a detailed description thereof will be omitted herein.

The entitlement server 520, which performs the profile transferring process, may transmit a second message requesting a new profile according to the profile transfer to the SM-DP+ server 530 in operation 1229. In an embodiment, the second message requesting the new profile may include an identifier of a profile. For example, the identifier of the profile may include a phone number (e.g., the phone number selected at the external electronic device 800) and/or an iccid of the profile, but there may be no limitation on a format of the identifier of the profile.

The SM-DP+ server 530, which receives the second message from the entitlement server 520, may generate the new profile mapped to the corresponding phone number based on the request for the new profile in operation 1231. After generating the new profile mapped to the corresponding phone number, the SM-DP+ server 530 may transmit a third message including download information used for downloading the generated new profile to the entitlement server 520 in operation 1233. In an embodiment, the download information may include an address of the SM-DP+ server 530 from which the new profile may be downloaded.

The entitlement server 520, which receives the third message including the download information used for downloading the new profile from the SM-DP+ server 530, may transmit a fourth message including download information used for downloading the new profile to the electronic device 101 in operation 1235. The download information used for downloading the new profile included in the fourth message transmitted in operation 1235 may be the same as the download information used for downloading the new profile included in the third message transmitted in operation 1233, or may be based on at least part of the download information used for downloading the new profile included in the third message. The fourth message may be implemented similarly to or substantially the same as that described in FIGS. 8A and 8B, so a detailed description thereof will be omitted herein.

In an embodiment, the download information may correspond to a web page. In an embodiment, if the web page is displayed, information may be displayed to the user before the second message is transmitted, or a web page for confirming a final transmission may be displayed to the user. In this way, if the download information corresponding to the web page is provided, the web page may be displayed before the second message is transmitted.

The electronic device 101, which receives the fourth message including the download information used for downloading the new profile from the entitlement server 520, may download a generated new profile from the SM-DP+ server 530 based on the download information in operation 1237.

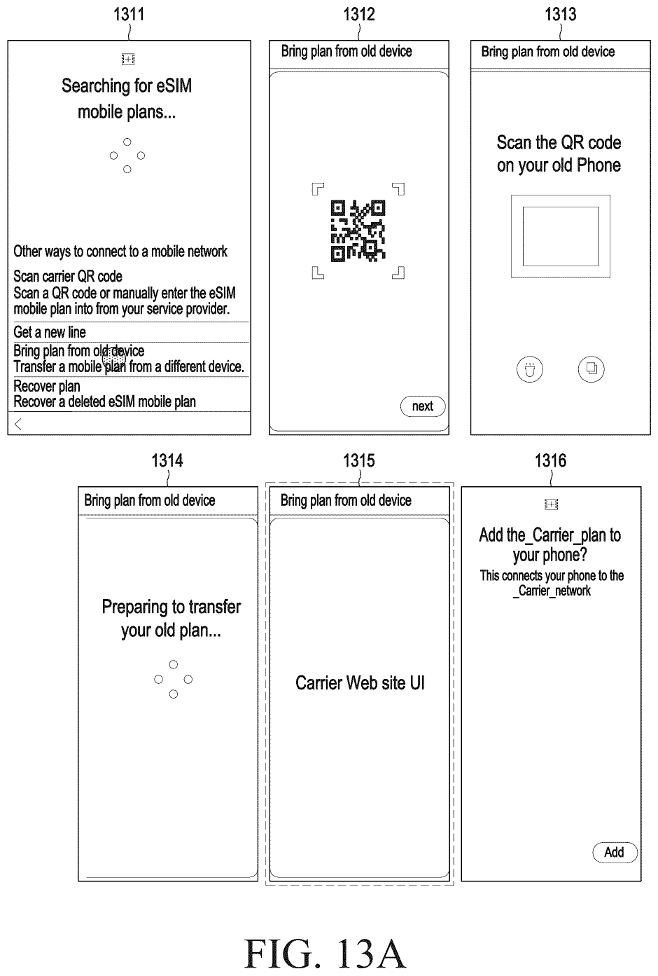

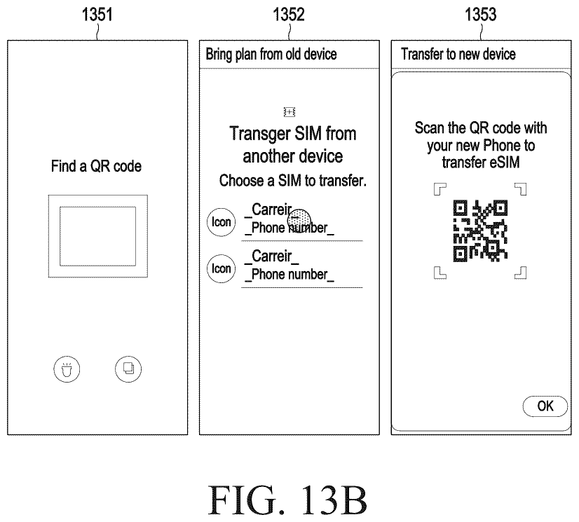

FIG. 13A is a diagram for describing screens displayed on an electronic device according to an embodiment of the disclosure.

FIG. 13B is a diagram for describing screens displayed on an electronic device according to an embodiment of the disclosure.

Screens 1311 to 1316 illustrated in FIG. 13A may be screens provided by a new electronic device (an electronic device (e.g., an electronic device 101 in FIG. 1A, 1B, 2, 3, 5, 8A, 8B, 10, 12A, or 12B)) according to a profile transferring process between electronic devices described in FIGS. 12A and 12B. Screens 1351 and 1353 illustrated in FIG. 13B may be screens provided by an existing electronic device (e.g., an external electronic device (e.g., an electronic device 102 or an electronic device 104 in FIG. 1A, or an external electronic device 800 in FIG. 8A, 8B, 10, 12A, or 12B) according to a profile transferring process between electronic devices described in FIGS. 12A and 12B. The profile transferring process described in FIGS. 12A and 12B may be a profile transferring process in a case that an electronic device, which is the new electronic device, triggers the profile transferring process, obtains profile transfer information from an external electronic device, which is the existing electronic device, and requests profile transfer from an entitlement server (e.g., an entitlement server 520 in FIG. 5, 8A, 8B, 10, 12A, or 12B) based on the obtained profile transfer information.

Referring to FIGS. 13A and 13B, the electronic device, which is the new electronic device, may output (for example, may display) a screen 1311 for selecting to transfer, to the electronic device, a profile of the external electronic device, which is the existing electronic device. The screen 1311 may be associated with operation 1211 in FIG. 12A.

When identifying a user input for selecting the profile transfer between the electronic devices via the screen 1311, the electronic device may output a screen 1312 which provides a QR code corresponding to the profile transfer information. The screen 1312 may be associated with operation 1213 in FIG. 12A.

The external electronic device may obtain the profile transfer information by scanning the QR code outputted on the screen 1312, which may correspond to a screen 1351. The screen 1351 may be associated with operation 1215 in FIG. 12A. The external electronic device, which obtains the profile transfer information via the screen 1351, may output a list including at least one phone number of the external electronic device (e.g., at least one phone number for which profile transfer is possible), and this may correspond to a screen 1352. The screen 1352 may be associated with operation 1217 in FIG. 12A.

When identifying a user input for selecting a phone number which is a target among the at least one phone number of the external electronic device via the screen 1352, the external electronic device may output a screen 1353 for providing a QR code which corresponds to the profile transfer information. The screen 1353 may be associated with operation 1221 in FIG. 12A.

The electronic device may obtain the profile transfer information by scanning the QR code outputted on the screen 1353, which may correspond to a screen 1313. The screen 1313 may be associated with operation 1223 in FIG. 12A. The electronic device, which obtains the profile transfer information via the screen 1313, may transmit a first message requesting the profile transfer to an entitlement server 520 (e.g., an entitlement server 520 in FIG. 5, 8A, 8B, 10, 12A, or 12B), thereby the profile transferring process may be performed, and this may correspond to a screen 1314. The screen 1314 may be associated with operation 1225 in FIG. 12A. The first message may be implemented similarly to or substantially the same as that described in FIGS. 8A and 8B, so a detailed description thereof will be omitted herein.

As the profile transferring process is performed in this way, the electronic device may receive a fourth message including the download information used for downloading the new profile from the entitlement server, and output a web page corresponding to the download information, and this may correspond to a screen 1315. The screen 1315 may be associated with operation 1235 in FIG. 12B. The fourth message may be implemented similarly to or substantially the same as that described in FIGS. 8A and 8B, so a detailed description thereof will be omitted herein.

As described in operation 1235, if the web page is displayed, information may be displayed to a user before a second message is transmitted, or a web page for confirmation of the final transmission may be displayed to the user. In this way, if the download information corresponding to the web page is provided, the web page may be displayed before the second message is transmitted.

The electronic device, which obtains the download information, may download the new profile from an SM-DP+ server (e.g., an SM-DP+ server 220 in FIG. 2, or an SM-DP+ server 530 in FIG. 5, 8A, 8B, 10, 12A, or 12B) based on the download information, and this may correspond to a screen 1316. The screen 1316 may be associated with operation 1237 in FIG. 12B.

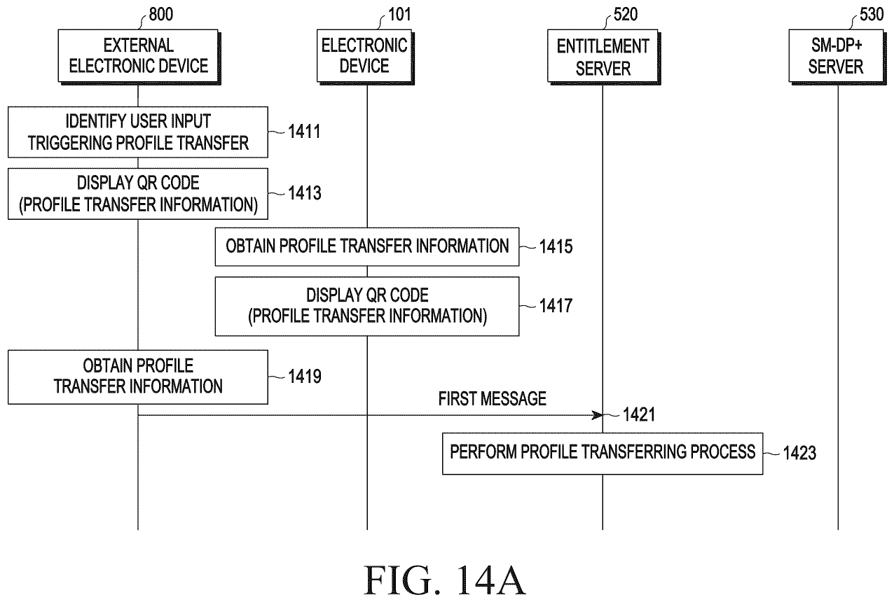

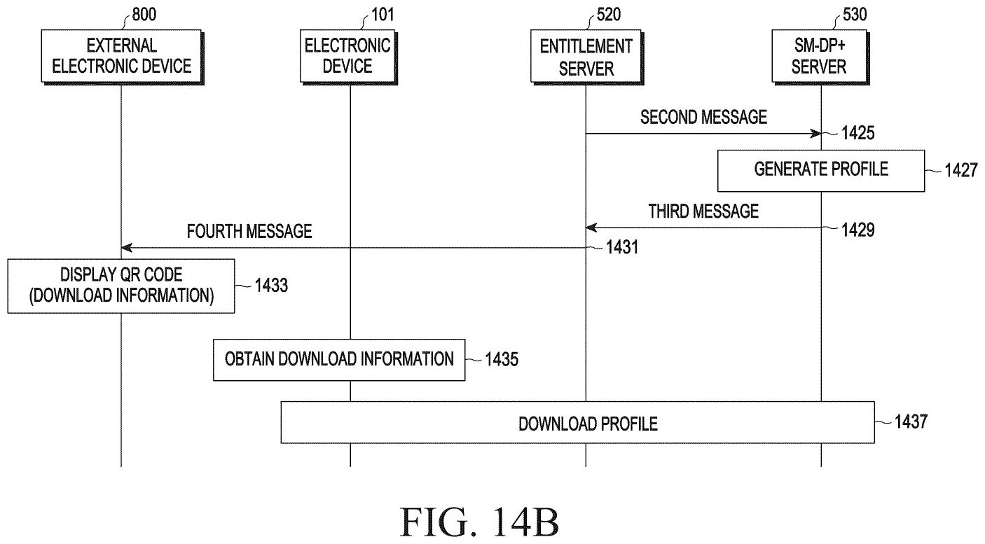

FIG. 14A is a signal flowchart illustrating a profile transferring process between electronic devices according to an embodiment of the disclosure.

FIG. 14B is a signal flowchart illustrating a profile transferring process between electronic devices according to an embodiment of the disclosure.

A profile transferring process between electronic devices illustrated in FIGS. 14A and 14B may be a profile transferring process between electronic devices in a case that an external electronic device 800 (e.g., an electronic device 102 or an electronic device 104 in FIG. 1A, or an external electronic device 800 in FIG. 8A, 8B, 10, 12A, or 12B), which is an existing electronic device, triggers profile transfer between the external electronic device 800 and an electronic device 101 (e.g., an electronic device 101 in FIG. 1A, 1B, 2, 3, 5, 8A, 8B, 10, 12A, or 12B) which is a new electronic device. However, in a profile transferring process between electronic devices illustrated in FIG. 10, the external electronic device 800, which is the existing electronic device, may trigger profile transfer, and the electronic device 101, which is the new electronic device, may obtain profile transfer information from the external electronic device 800, and request the profile transfer from an entitlement server 520 based on the profile transfer information which the electronic device 101 obtains from the external electronic device 800. Alternatively, in a profile transferring process between electronic devices illustrated in FIGS. 14A and 14B, the external electronic device 800, which is the existing electronic device, may trigger profile transfer, the electronic device 101, which is the new electronic device, may obtain profile transfer information from the external electronic device 800, provide profile transfer information of the electronic device 101 based on the profile transfer information obtained by the electronic device 101, and the external electronic device 800 may request the profile transfer from an entitlement server 520 based on the profile transfer information provided by the electronic device 101. In an embodiment, the new electronic device may be an electronic device which will download a profile, and the existing electronic device may be an electronic device in which the profile has already been downloaded.

Referring to FIGS. 14A and 14B, in operation 1411, the external electronic device 800 may identify a user input which triggers profile transfer between electronic devices (e.g., a user input selecting the profile transfer between the electronic devices). For example, the external electronic device 800 may output (e.g., display) a UI for selecting the profile transfer between the electronic devices (e.g., a profile transfer menu between electronic devices), and identify the user input via the UI. The UI may include information indicating a purpose of selecting to transfer the profile of the external electronic device 800 to the electronic device 101, or information indicating a purpose of selecting to transfer the profile (or subscription or line) from the external electronic device 800 to the electronic device 101 for intuitive recognition by a user. In an embodiment, the UI for selecting the profile transfer between the electronic devices may be provided in a form of a sub-menu mapped to at least one phone number of the external electronic device 800.

Based on the user input selecting the profile transfer between the electronic devices (or subscription transfer between the electronic devices, or line transfer between the electronic devices), the external electronic device 800 may display a QR code in operation 1413. Displaying the QR code may be an example of providing profile transfer information which is information related to the profile transfer between the electronic devices (or subscription transfer between the electronic devices, or line transfer between the electronic devices). In an embodiment, a set security scheme such as raw data and/or hashing may be applied to the QR code. By providing the profile transfer information in the form of the QR code, a separate wireless connection (e.g., a wireless connection based on a short-range wireless communication scheme such as a Bluetooth scheme, a Wi-Fi scheme, a UWB scheme, and/or an NFC scheme, or a wireless connection based on a cellular communication scheme such as an LTE scheme, an LTE-A scheme, and/or an NR scheme) may not be required between the electronic devices for the profile transfer between the electronic devices.

In an embodiment, the profile transfer information may be information related to the profile transfer from the existing electronic device (or an existing device) to the new electronic device (or a new device). In an embodiment, the profile may be stored in an eSIM (e.g., a subscriber identity module 196 in FIG. 1A, an eSIM 201 in FIG. 1B, 2, or 3, or an eUICC 401 in FIG. 4) of the existing electronic device, or may be stored in a physical SIM of the existing electronic device, or may be downloaded from an SM-DP+ server (e.g., an SM-DP+ server 220 in FIG. 2, or an SM-DP+ server 530 in FIG. 5, 8A, 8B, 10, 12A, or 12B). For example, transferring the subscription of the existing electronic device to the new electronic device may mean transferring a profile corresponding to a profile stored in the existing electronic device to the new electronic device. In FIGS. 14A and 14B, because it is assumed that the electronic device 101 is the new electronic device and the external electronic device 800 is the existing electronic device, the profile transfer information may be information related to the profile transfer from the external electronic device 800 to the electronic device 101.

In an embodiment, the profile transfer information may include at least one of a prefix, an operation type, device information, authentication information, an address of an entitlement server (e.g., an entitlement server 520 in FIG. 5, 8A, 8B, 10, 12A, or 12B), or a phone number. The prefix, the operation type, the device information, the authentication information, the address of the entitlement server, and/or the phone number which may be included in the profile transfer information may be implemented similarly to or substantially the same as described in FIGS. 8A and 8B, so a detailed description thereof will be omitted herein.

In FIGS. 14A and 14B, it has been assumed that the electronic device 101 is the new electronic device and the external electronic device 800 is the existing electronic device, so the profile transfer information may be information related to profile transfer from the external electronic device 800 to the electronic device 101, and the profile transfer information corresponding to the QR code displayed by the external electronic device 800 in operation 1413 may include a prefix, and/or an operation type.

For example, the QR code corresponding to the profile transfer information displayed in operation 1413 may be expressed as Table 9 below.

TABLE 9

ODSA$2

The external electronic device 800 is a source electronic device which provides the profile transfer information, so a value of the operation type in Table 9 is set to “2”. In Table 9, ODSA may be a prefix.

In this way, if the external electronic device 800, which is the existing electronic device, displays the QR code corresponding to the profile transfer information, the electronic device 101, which is the new electronic device, may cause the electronic device 101 to start the profile transferring process between the electronic device 101 and the external electronic device 800 by scanning the QR code outputted on the external electronic device 800. In this way, the profile transfer information is provided in the form of the QR code, so even if a separate wireless connection does not exist between the electronic device 101 and the external electronic device 800, the profile transfer between the electronic device 101 and the external electronic device 800 may be possible.

In operation 1415, the electronic device 101 may obtain the profile transfer information. For example, if the external electronic device 800 outputs the profile transfer information in the form of the QR code, the electronic device 101 may obtain the profile transfer information by scanning the QR code outputted from the external electronic device 800.

The external electronic device 800, which obtains the profile transfer information, may identify the value of the operation type included in the profile transfer information. The value of the operation type included in the profile transfer information is set to “2”, so the electronic device 101 may identify that the profile transfer information is provided from the external electronic device 800 which is the existing electronic device. The electronic device 101, which identifies that the profile transfer information is provided from the external electronic device 800, may display a QR code in operation 1417. In an embodiment, displaying the QR code may be an example of providing profile transfer information which is information related to the profile transfer between the electronic devices (or subscription transfer between the electronic devices, or line transfer between the electronic devices).

The profile transfer information corresponding to the QR code displayed by the electronic device 101 in operation 1417 may include a prefix, an operation type, and/or device information.

The device information included in the profile transfer information in operation 1417 may be the device information of the electronic device 101, and may include the IMEI, the EID, and/or the model name of the electronic device 101.

For example, the QR code corresponding to the profile transfer information displayed in operation 1417 may be expressed as Table 10 below.

TABLE 10
ODSA$1$354707530000000$89043051202200006222001111111111$SM-S911B

The electronic device 101 is a source electronic device which provides the profile transfer information, so a value of the operation type in Table 10 is set to “1”. In Table 10, ODSA may be the prefix, 354707530000000 may be the IMEI of the electronic device 101, 89043051202200006222001111111111 may be the EID of the electronic device 101, and SM-S911B may be the model name of the electronic device 101.

In this way, if the electronic device 101, which is the new electronic device, displays the QR code corresponding to the profile transfer information, the external electronic device 800, which is the existing electronic device, may obtain the profile transfer information by scanning the QR code outputted on the electronic device 101.

In operation 1419, the external electronic device 800 may obtain the profile transfer information. For example, if the electronic device 101 outputs the profile transfer information in the form of the QR code, the external electronic device 800 may obtain the profile transfer information by scanning the QR code outputted from the electronic device 101.

The external electronic device 800, which obtains the profile transfer information, may identify the value of the operation type included in the profile transfer information. The value of the operation type included in the profile transfer information is set to “1”, so the external electronic device 800 may identify that the profile transfer information is provided from the electronic device 101, which is the new electronic device. The external electronic device 800, which identifies that the profile transfer information is provided from the electronic device 101, may perform an authentication process (e.g., an EAP-AKA authentication process) with the entitlement server 520 to obtain authentication information, and transmit a first message requesting profile transfer (or subscription transfer) to the entitlement server 520 based on the authentication information in operation 1421. A user input for triggering the profile transfer between the electronic devices (e.g., a user input for selecting the profile transfer between the electronic devices) in a form of a sub-menu mapped to a phone number of the external electronic device 800 has been identified in operation 1411, so the external electronic device 800 may identify a phone number which is a target for the profile transfer as the phone number in operation 1411.

The entitlement server 520, which receives the first message requesting the profile transfer from the external electronic device 800, may perform a profile transferring process in operation 1423. In an embodiment, the profile transferring process may be implemented similarly to or substantially the same as specified in “8. Primary ODSA Procedure Call Flows” in a standard document TS. 43 (e.g., TS. 43 Version 9, so a detailed description thereof will be omitted herein.

The entitlement server 520, which performs the profile transferring process, may transmit a second message requesting a new profile according to the profile transfer to the SM-DP+ server 530 in operation 1425. In an embodiment, the second message requesting the new profile may include an identifier of a profile. For example, the identifier of the profile may include a phone number (e.g., the phone number of the external electronic device 800) and/or an iccid of the profile, but there may be no limitation on a format of the identifier of the profile.

The SM-DP+ server 530, which receives the second message from the entitlement server 520, may generate the new profile mapped to the corresponding phone number based on the request for the new profile in operation 1427. After generating the new profile mapped to the corresponding phone number, the SM-DP+ server 530 may transmit a third message including download information used for downloading the generated new profile to the entitlement server 520 in operation 1429. In an embodiment, the download information may include an address of the SM-DP+ server 530 from which the new profile may be downloaded.

The entitlement server 520, which receives the third message including the download information used for downloading the new profile from the SM-DP+ server 530, may transmit a fourth message including download information used for downloading the new profile to the external electronic device 800 in operation 1431. The download information used for downloading the new profile included in the fourth message transmitted in operation 1431 may be the same as the download information used for downloading the new profile included in the third message transmitted in operation 1429, or may be based on at least part of the download information used for downloading the new profile included in the third message.

The external electronic device 800, which receives the fourth message including the download information used for downloading the new profile from the entitlement server 520, may obtain the download information used for downloading the new profile included in the fourth message, and output (for example, may display) the download information used for downloading the new profile in a form of a QR code. In an embodiment, a format of the download information used for downloading the new profile may be implemented similarly to or substantially the same as specified in “4.1 Activation Code” in a standard document SGP. 22 (e.g., SGP. 22 Version 3.0), and the standard document SGP. 22 (e.g., SGP. 22 Version 3.0) specifies Activation Code as shown in Table 5 above. Therefore, a detailed description of the format of the download information used for downloading the new profile will be omitted.

In operation 1435, the electronic device 101 may obtain the download information used for downloading the new profile. For example, if the external electronic device 800 outputs the download information used for downloading the new profile in the form of the QR code, the electronic device 101 may scan the QR code outputted from the external electronic device 800 to obtain the download information used for downloading the new profile. In this way, the external electronic device 800 outputs the download information used for downloading the new profile in the form of the QR code, thereby a separate wireless connection (e.g., a wireless connection based on a short-range wireless communication scheme such as a Bluetooth scheme, a Wi-Fi scheme, a UWB scheme, and/or an NFC scheme, or a wireless connection based on a cellular communication scheme such as an LTE scheme, an LTE-A method, and/or an NR scheme) may not be necessary.

The electronic device 101, which obtains the download information, may download the generated new profile from the SM-DP+ server 530 based on the download information in operation 1437.

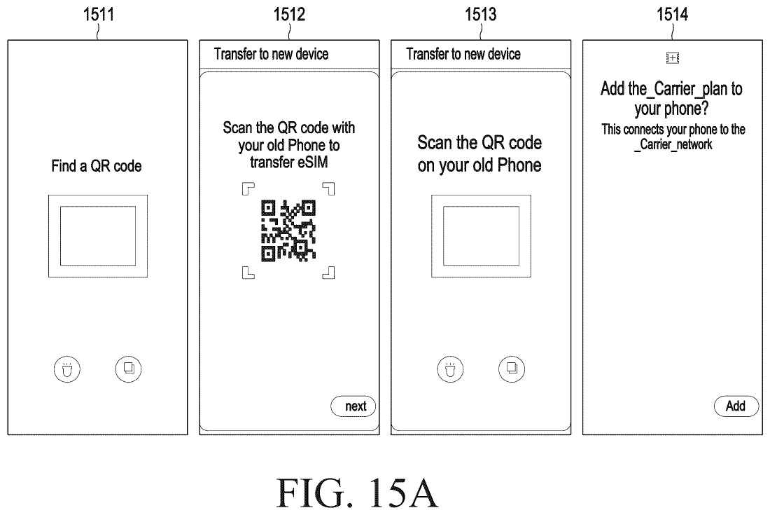

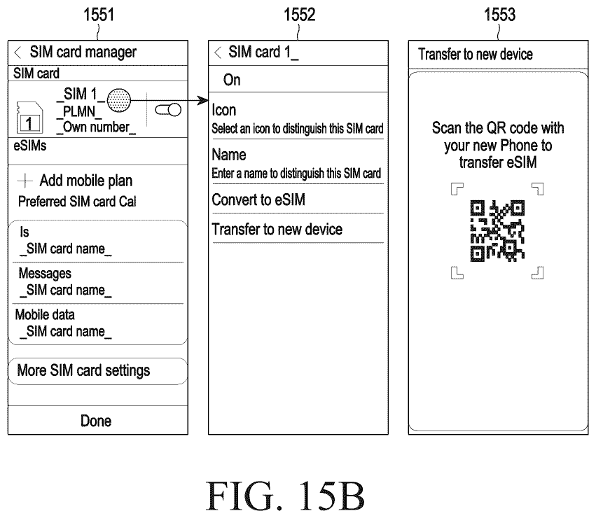

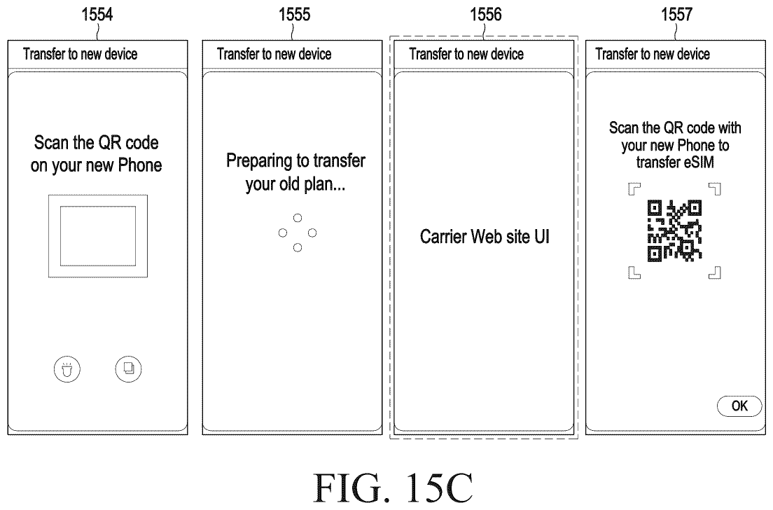

FIG. 15A is a diagram for describing screens displayed on an electronic device according to an embodiment of the disclosure.

FIG. 15B is a diagram for describing screens displayed on an electronic device according to an embodiment of the disclosure.

FIG. 15C is a diagram for describing screens displayed on an electronic device according to an embodiment of the disclosure.

Screens 1511 to 1514 illustrated in FIG. 15A may be screens provided by a new electronic device (an electronic device (e.g., an electronic device 101 in FIG. 1A, 1B, 2, 3, 5, 8A, 8B, 10, 12A, 12B, 14A, or 14B)) according to a profile transferring process between electronic devices described in FIGS. 14A and 14B. Screens 1551 to 1557 illustrated in FIGS. 15B and 15C may be screens provided by an existing electronic device (e.g., an external electronic device (e.g., an electronic device 102 or an electronic device 104 in FIG. 1A, or an external electronic device 800 in FIG. 8A, 8B, 10, 12A, 12B, 14A, or 14B)) according to a profile transferring process between electronic devices described in FIGS. 14A and 14B. The profile transferring process described in FIGS. 14A and 14B may be a profile transferring process in a case that an external electronic device, which is the existing electronic device, triggers the profile transferring process, obtains profile transfer information from an electronic device, which is the new electronic device, and requests profile transfer from an entitlement server (e.g., an entitlement server 520 in FIG. 5, 8A, 8B, 10, 12A, 12B, 14A, or 14B) based on the obtained profile transfer information.

Referring to FIGS. 15A to 15C, the external electronic device, which is the existing electronic device, may output (for example, may display) screens 1551 and 1552 for selecting to transfer, to the electronic device which is the new electronic device, a profile of the external electronic device. The screens 1551 and 1552 may be associated with operation 1411 in FIG. 14A.

When identifying a user input for selecting the profile transfer between the electronic devices via the screen 1551 and 1552, the external electronic device may output a screen 1553 which provides a QR code corresponding to the profile transfer information. The screen 1553 may be associated with operation 1413 in FIG. 14A.

The electronic device may obtain the profile transfer information by scanning the QR code outputted on the screen 1553, and this may correspond to the screen 1511. The screen 1511 may be associated with operation 1415 in FIG. 14A. The electronic device, which obtains the profile transfer information via the screen 1511, may output a screen 1512 which provides a QR code corresponding to the profile transfer information. The screen 1512 may be associated with operation 1417 in FIG. 14A.

The external electronic device may obtain the profile transfer information by scanning the QR code outputted on the screen 1512, and this may correspond to a screen 1554. The screen 1554 may be associated with operation 1419 in FIG. 14A.

The external electronic device, which obtains the profile transfer information, may perform a profile transfer process by transmitting a first message requesting profile transfer to an entitlement server (e.g., an entitlement server 520 in FIG. 5, 8A, 8B, 10, 12A, 12B, 14A, or 14B), and this may correspond to a screen 1555. The screen 1555 may be associated with operation 1421 in FIG. 14A.

As the profile transfer process is performed in this way, the electronic device may receive a fourth message including download information used for downloading a new profile from the entitlement server, and output a web page or a QR code which corresponds to the download information, and this may correspond to a screen 1556 or a screen 1557. The screen 1556 or the screen 1557 may be associated with operation 1433 in FIG. 14B.

The electronic device may obtain the download information by scanning the QR code outputted on a screen 1557, and this may correspond to a screen 1513. The screen 1513 may be associated with operation 1435 in FIG. 14A.

The electronic device, which obtains the download information, may download a new profile from an SM-DP+ server (e.g., an SM-DP+ server 220 in FIG. 2, or an SM-DP+ server 530 in FIG. 5, 8A, 8B, 10, 12A, 12B, 14A, or 14B) based on the download information, and this may correspond to a screen 1514. The screen 1514 may be associated with operation 1437 in FIG. 14B.

According to an embodiment of the disclosure, a method may include identifying a user input which triggers a profile transfer from an external electronic device (102; 104; 800) to an electronic device (101).

According to an embodiment of the disclosure, the method may include providing information related to the profile transfer based on the user input.

According to an embodiment of the disclosure, the method may include obtaining, from the external electronic device, information for downloading a profile.

According to an embodiment of the disclosure, the information related to the profile transfer may include information indicating that the information related to the profile transfer is provided by the electronic device to download the profile.

According to an embodiment of the disclosure, the method may include downloading the profile from a server (220; 530) related to the profile transfer based on the information for downloading the profile.

According to an embodiment of the disclosure, the information for downloading the profile may include an address of the server.

According to an embodiment of the disclosure, the information related to the profile transfer may include a prefix including a set string.

According to an embodiment of the disclosure, the information related to the profile transfer may include device information of the electronic device.

According to an embodiment of the disclosure, the device information may include at least one of an international mobile equipment identity (IMEI), an embedded universal integrated circuit card (eUICC) identifier (ID) (eUICC ID: EID), a model name, or a serial number of the electronic device.

According to an embodiment of the disclosure, the information related to the profile transfer may be provided in a form of a quick response (QR) code.

According to an embodiment of the disclosure, the information for downloading the profile may be provided in a form of a quick response (QR) code.

According to an embodiment of the disclosure, a method may include obtaining information related to profile transfer from an electronic device (102; 104; 800) to an external electronic device (101).

According to an embodiment of the disclosure, the method may include providing at least one phone number of the electronic device based on obtainment of the information related to the profile transfer.

According to an embodiment of the disclosure, the method may include identifying a user input related to a phone number which is a target for the profile transfer among the at least one phone number.

According to an embodiment of the disclosure, the method may include transmitting a message requesting a profile transfer to a server (520) related to the profile transfer based on the user input.

According to an embodiment of the disclosure, the method may include receiving information for downloading the profile from the server in response to the message.

According to an embodiment of the disclosure, the method may include providing the information for downloading the profile.

According to an embodiment of the disclosure, the information related to the profile transfer may include information indicating that the information related to the profile transfer is provided by the external electronic device to download the profile.

According to an embodiment of the disclosure, the information for downloading the profile may include an address of another server (220; 530) related to the profile transfer.

According to an embodiment of the disclosure, the information related to the profile transfer may include a prefix including a set string.

According to an embodiment of the disclosure, the information related to the profile transfer may include device information of the external electronic device.

According to an embodiment of the disclosure, the device information may include at least one of an international mobile equipment identity (IMEI), an embedded universal integrated circuit card (eUICC) identifier (ID) (eUICC ID: EID), a model name, or a serial number of the external electronic device.

According to an embodiment of the disclosure, the information related to the profile transfer may be provided in a form of a quick response (QR) code.

According to an embodiment of the disclosure, the information for downloading the profile may be provided in a form of a quick response (QR) code.

In accordance with another aspect of the disclosure, one or more non-transitory computer-readable storage media storing one or more computer programs including computer-executable instructions are provided.

According to an embodiment of the disclosure, the one or more computer programs including computer-executable instructions that, when executed by one or more processors (120) of an electronic device (101), cause the electronic device to perform operations.

According to an embodiment of the disclosure, the operations may include identifying a user input which triggers a profile transfer from an external electronic device (102; 104; 800) to an electronic device (101).

According to an embodiment of the disclosure, the operations may include providing information related to the profile transfer based on the user input.

According to an embodiment of the disclosure, the operations may include obtaining, from the external electronic device, information for downloading a profile.

According to an embodiment of the disclosure, the information related to the profile transfer may include information indicating that the information related to the profile transfer is provided by the electronic device to download the profile.

In accordance with another aspect of the disclosure, one or more non-transitory computer-readable storage media storing one or more computer programs including computer-executable instructions are provided.

According to an embodiment of the disclosure, the one or more computer programs including computer-executable instructions that, when executed by one or more processors (120) of an electronic device (102; 104; 800), cause the electronic device to perform operations.

According to an embodiment of the disclosure, the operations may include obtaining information related to a profile transfer from the electronic device to an external electronic device (101).

According to an embodiment of the disclosure, the operations may include providing at least one phone number of the electronic device based on obtainment of the information related to the profile transfer.

According to an embodiment of the disclosure, the operations may include identifying a user input related to a phone number which is a target for the profile transfer among the at least one phone number.

According to an embodiment of the disclosure, the operations may include transmitting a message requesting the profile transfer to a server (520) related to the profile transfer based on the user input.

According to an embodiment of the disclosure, the operations may include receiving information for downloading the profile from the server in response to the message.

According to an embodiment of the disclosure, the operations may include providing the information for downloading the profile.

According to an embodiment of the disclosure, the information related to the profile transfer may include information indicating that the information related to the profile transfer is provided by the external electronic device to download the profile.

According to an embodiment of the disclosure, a method performed by an electronic device may be provided.

According to an embodiment of the disclosure, the method may include identifying a user input which triggers a profile transfer to an external electronic device.

According to an embodiment of the disclosure, the method may include providing first information related to the profile transfer based on the user input.

According to an embodiment of the disclosure, the method may include obtaining, from the external electronic device, first information for downloading a profile.

According to an embodiment of the disclosure, the method may include providing, to a server, a request for the profile transfer.

According to an embodiment of the disclosure, the method may include obtaining, from the server, second information for downloading the profile.

According to an embodiment of the disclosure, the method may include providing second information related to the profile transfer based on the second information for downloading the profile.

According to an embodiment of the disclosure, the first information related to the profile transfer and the second information related to the profile transfer may be provided in quick response (QR) code form.

According to an embodiment of the disclosure, one or more non-transitory computer-readable storage media storing one or more computer programs may be provided.

According to an embodiment of the disclosure, the one or more computer programs may include computer-executable instructions that, when executed by one or more processors of an electronic device, cause the electronic device to perform operations.

According to an embodiment of the disclosure, the operations may include identifying a user input which triggers a profile transfer from an external electronic device to the electronic device.

According to an embodiment of the disclosure, the operations may include providing information related to the profile transfer based on the user input.

According to an embodiment of the disclosure, the operations may include obtaining, from the external electronic device, information for downloading a profile.

According to an embodiment of the disclosure, the information related to the profile transfer includes information indicating that the information related to the profile transfer may be provided by the electronic device to download the profile.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
at least one communication circuit;
at least one processor; and
memory storing instructions that, when executed by the at least one processor, cause the electronic device to:
identify a user input which triggers a profile transfer from an external electronic device to the electronic device,
provide information related to the profile transfer based on the user input, and
obtain, from the external electronic device, information for downloading a profile,
wherein the information related to the profile transfer includes information indicating that the information related to the profile transfer is provided by the electronic device to download the profile.

2. The electronic device of claim 1, wherein the instructions, when executed by the at least one processor, cause the electronic device to:
download the profile from a server related to the profile transfer via the at least one communication circuit, based on the information for downloading the profile.

3. The electronic device of claim 2, wherein the information for downloading the profile includes an address of the server.

4. The electronic device of claim 1, wherein the information related to the profile transfer further includes a prefix including a set string.

5. The electronic device of claim 1,
wherein the information related to the profile transfer further includes device information of the electronic device, and
wherein the device information includes at least one of an international mobile equipment identity (IMEI), an embedded universal integrated circuit card (eUICC) identifier (ID) (eUICC ID: EID), a model name, or a serial number of the electronic device.

6. The electronic device of claim 1, wherein the information related to the profile transfer is provided in a form of a quick response (QR) code.

7. The electronic device of claim 1, wherein the information for downloading the profile is provided in a form of a quick response (QR) code.

8. An electronic device, comprising:
at least one communication circuit;
at least one processor; and
memory storing instructions that, when executed by the at least one processor, cause the electronic device to:
obtain information related to a profile transfer from the electronic device to an external electronic device,
provide at least one phone number of the electronic device based on obtainment of the information related to the profile transfer,
identify a user input related to a phone number which is a target for the profile transfer among the at least one phone number,
transmit a message requesting the profile transfer to a server related to the profile transfer via the at least one communication circuit based on the user input,
receive information for downloading the profile from the server via the at least one communication circuit in response to the message, and
provide the information for downloading the profile,
wherein the information related to the profile transfer includes information indicating that the information related to the profile transfer is provided by the external electronic device to download the profile.

9. The electronic device of claim 8, wherein the information for downloading the profile includes an address of another server related to the profile transfer.

10. The electronic device of claim 8, wherein the information related to the profile transfer further includes a prefix including a set string.

11. The electronic device of claim 8,
wherein the information related to the profile transfer further includes device information of the external electronic device, and
wherein the device information includes at least one of an international mobile equipment identity (IMEI), an embedded universal integrated circuit card (eUICC) identifier (ID) (eUICC ID: EID), a model name, or a serial number of the external electronic device.

12. The electronic device of claim 8, wherein the information related to the profile transfer is provided in a form of a quick response (QR) code.

13. The electronic device of claim 8, wherein the information for downloading the profile is provided in a form of a quick response (QR) code.

14. A method, comprising:
identifying a user input which triggers a profile transfer from an external electronic device to an electronic device;
providing information related to the profile transfer based on the user input; and
obtaining, from the external electronic device, information for downloading a profile,
wherein the information related to the profile transfer includes information indicating that the information related to the profile transfer is provided by the electronic device to download the profile.

15. The method of claim 14, further comprising:
downloading the profile from a server related to the profile transfer based on the information for downloading the profile.

16. The method of claim 15, wherein the information for downloading the profile includes an address of the server.

17. The method of claim 14, wherein the information related to the profile transfer further includes a prefix including a set string.

18. The method of claim 14,
wherein the information related to the profile transfer further includes device information of the electronic device, and
wherein the device information includes at least one of an international mobile equipment identity (IMEI), an embedded universal integrated circuit card (eUICC) identifier (ID) (eUICC ID: EID), a model name, or a serial number of the electronic device.

19. The method of claim 14, wherein the information related to the profile transfer is provided in a form of a quick response (QR) code.

20. The method of claim 14, wherein the information for downloading the profile is provided in a form of a quick response (QR) code.
